(19) United States
(12) Patent Application Publication
(10) Pub. No.: US 2016/0019161 A1
(43) Pub. Date: Jan. 21, 2016

(54) PROGRAMMABLE ADDRESS MAPPING AND MEMORY ACCESS OPERATIONS

(71) Applicant: HEWLETT-PACKARD DEVELOPMENT COMPANY, L.P., Houston, TX (US)

(72) Inventors: Tushar Patel, Houston, TX (US); Terence P. Kelly, Palo Alto, CA (US); Mitchel E. Wright, Houston, TX (US)

(21) Appl. No.: 14/773,549

(22) PCT Filed: Mar. 12, 2013
(86) PCT No.: PCT/US2013/030545

§ 371 Date: Sep. 8, 2015

(51) Int. Cl. G06F 12/10; G06F 13/16

(52) U.S. Cl. CPC G06F 12/1036; G06F 12/109; G06F 13/1689; G06F 2212/657; G06F 2212/305

(57) ABSTRACT

Programmable address mapping and memory access operations are disclosed. An example apparatus includes an address translator to translate a first host physical address to a first intermediate address. The example apparatus also includes a programmable address decoder to decode the first intermediate address to a first hardware memory address of a first addressable memory location in a memory, the programmable address decoder to receive a first command to associate the first host physical address with a second addressable memory location in the memory by changing a mapping between the first intermediate address and a second hardware memory address of the second addressable memory location.

### BACKGROUND

A processor of a computing system executes instructions of computer programs to perform operations on data. A memory of the computing system stores the computer programs and/or the data which can be accessed by the processor. To allow storing and accessing information, computing systems include memory devices that are addressable to perform write operations to store data at particular selected locations in memory devices and to read data from particular selected locations in the memory devices.

### BRIEF DESCRIPTION OF THE DRAWINGS

FIG. 1A is an example address translator and programmable address decoder (PAD) constructed in accordance with the teachings of this disclosure.

FIG. 1B is an example computer system having a memory controller with the address translator and PAD of FIG. 1A.

FIG. 1C depicts the memory controller of FIG. 1B and logical representations of the PAD of FIGS. 1A and 1B.

FIG. 1D depicts an example using a prior memory controller in combination with the address translator and the PAD of FIGS. 1A and 1B.

FIGS. 2 and 3 illustrate an example manner of how the example address translator and the example PAD of FIGS. 1A-1D decode host physical addresses to access an array of addressable memory locations.

FIGS. 4A and 4B illustrate an example logic circuit and a state machine that may be used to implement the PAD of FIGS. 1A, 1B and 1C.

FIG. 5 is a timing diagram illustrating signals used by the example PAD of FIGS. 1A-1D and 2-4 to perform a write operation.

FIG. 6 is a timing diagram illustrating signals used by the example PAD of FIGS. 1A-1D and 2-4 to perform a read operation.

FIG. 7 is a timing diagram illustrating signals used by the example PAD of FIGS. 1A-1D and 2-4 to perform a shift up operation.

FIG. 8 is a timing diagram illustrating signals used by the example PAD of FIGS. 1A-1D and 2-4 to perform a shift down operation.

FIG. 9 is a timing diagram illustrating signals used by the example PAD of FIGS. 1A-1D and 2-4 to perform a remap operation.

FIG. 10 is a timing diagram illustrating signals used by the example PAD of FIGS. 1A-1D and 2-4 to perform an insert operation.

FIG. 11 is a timing diagram illustrating signals used by the example PAD of FIGS. 1A-1D and 2-4 to perform a delete operation.

FIG. 12 is a timing diagram illustrating signals used by the example PAD of FIGS. 1A-1D and 2-4 to perform a partial shift up operation.

FIG. 13 is a timing diagram illustrating signals used by the example PAD of FIGS. 1A-1D and 2-4 to perform a partial shift down operation.

FIG. 14 is a flowchart representative of example machine readable instructions that may be executed to receive and execute commands from the processor of FIG. 1B.

FIG. 15 is a flowchart representative of example machine readable instructions that may be executed to perform a write operation.

FIG. 16 is a flowchart representative of example machine readable instructions that may be executed to perform a read operation.

FIG. 17 is a flowchart representative of example machine readable instructions that may be executed to perform a shift up operation.

FIG. 18 is a flowchart representative of example machine readable instructions that may be executed to perform a shift down operation.

FIG. 19 is a flowchart representative of example machine readable instructions that may be executed to perform a remap activate operation.

FIG. 20 is a flowchart representative of example machine readable instructions that may be executed to perform a remap operation.

FIG. 21 is a flowchart representative of example machine readable instructions that may be executed to perform an insert operation.

FIG. 22 is a flowchart representative of example machine readable instructions that may be executed to perform a delete operation.

FIG. 23 is a flowchart representative of example machine readable instructions that may be executed to perform a partial shift up operation.

FIG. 24 is a flowchart representative of example machine readable instructions that may be executed to perform a partial shift down operation.

FIG. 25 depicts a flow chart representative of example machine readable instructions that may be executed to perform commands received at the PAD of FIGS. 1A-1D and 2-3.

### DETAILED DESCRIPTION

Processors access memories of computing systems to execute instructions of computer programs to perform different operations. Memories store bits of data in memory devices that are addressable in different bit lengths based on different memory architectures and/or computing platforms. For example, memory devices may be addressable in bytes (e.g., 8 bits) or in different-size words (e.g., 16 bits, 32 bits, 64 bits, 128 bits, etc.). As used herein, a memory location storing a group of addressable bits (e.g., bytes, words, etc.) is referred to as an addressable memory location. In some instances, processors communicate with memories via separate memory controllers that manage the flow of data between processors and memories. A memory controller may be located on a memory module having the memory controller and memory chips such as a dual inline memory module (DIMM) having, for example, dynamic random access memory (DRAM) and/or any other type of volatile or non-volatile memory. In other examples, the memory controller is implemented as a chip mounted on a main computer printed circuit board (PCB) of a computing system.

Three types of memory addresses include logical (e.g., virtual) addresses, host physical addresses, and hardware memory addresses (or memory circuit addresses). Logical addresses are used by programs to perform memory accesses. Logical addresses are useful to abstract addressing used by software to access memory from the physical layout of memory in a computer system.

A memory management unit (MMU) of a processor translates logical addresses to host physical addresses using translation lookaside buffers (TLB's) so that the computing system can access physical memories at their host physical addresses corresponding to logical addresses used by software. To determine host physical addresses, TLB's use logical-to-physical memory maps in which physical memory address space is mapped to logical addresses useable by software. Such logical-to-physical memory maps allow changes in the physical arrangement, layout, mounting, etc., of physical memory without burdening software with needing to keep track of changes in host physical addresses of the physical memory. Instead, processors update logical-to-physical memory maps in TLBs to re-map logical addresses to new/different host physical addresses.

During a memory access request, after a processor determines a host physical address based on a logical address, the processor sends a memory access request to a memory controller using the host physical address. The memory controller then decodes the host physical address to a hardware memory address, or memory circuit address, of a memory device(s) having the addressable memory location corresponding to the host physical address. In examples disclosed herein, a hardware memory address, or memory circuit address, identifies physical memory modules, physical memory arrays, physical memory die/chips, and physical memory device locations (e.g., addressable groups of bit cells) within memory die/chips. A memory controller uses hardware memory addresses (or memory circuit addresses) to access memory devices so that the memory devices can determine on-die memory cell locations to control internal wordline and bitline circuitry that activates memory bits of different addressable memory locations corresponding to host physical addresses decoded by the memory controller. In some examples, such as in dynamic random access memory (DRAM) die/chips, memory addressable locations are accessible by interpreting a hardware address as a row address (communicated over a DRAM address bus concurrently with a row address strobe (RAS)) and a column address (communicated over a DRAM address bus concurrently with a column address strobe (CAS)).

In prior systems, when a processor specifies a host physical address, the memory controller decodes the host physical address to a hardware memory address using a static data structure that maps addressable memory locations of a memory device with sequential host physical addresses.

Example methods, apparatus, and articles of manufacture disclosed herein provide a memory controller with programmable operations. In particular, examples disclosed herein may be used to modify mappings between host physical addresses specified by processors and hardware memory addresses of memory addressable locations in memory devices. Such mapping modifications may be performed dynamically during runtime, during system boot phases, and/or during memory mounting phases using examples disclosed herein.

Examples disclosed herein include an address translator and a programmable address decoder (PAD). During a memory access request, the example address translator receives a physical memory address (e.g., a host physical memory address) from a processor (e.g., a host). Upon receiving the host physical address, the example address translator translates the host physical address to a PAD address. The PAD address is a logical intermediate address (i.e., an intermediate address) used internally by the example PAD. The example PAD receives the PAD address from the address translator and decodes the PAD address to a hardware memory address of the addressable memory location corresponding to the host physical address specified by the processor. An example memory controller can then perform a requested memory access operation at the decoded hardware memory address corresponding to the host physical address specified by the processor, such as writing to or reading from an addressable memory location at the decoded hardware memory address.

In examples disclosed herein, in addition to facilitating memory accesses, the memory controller modifies address mappings between host physical addresses and hardware memory addresses based on commands from a processor. In disclosed examples, the memory controller modifies address mappings by changing which PAD addresses correspond to which hardware memory addresses. For example, an address translator modifies a PAD address to change a mapping between a host physical address and the modified PAD address, which causes the host physical address to be mapped to a different hardware memory address. Accordingly, memory mapping between host physical addresses and real hardware memory locations where data is stored in memory cells may be handled by a memory controller that is separate from a processor and that includes the address translator and the PAD. In this manner, a processor need not manage tracking of host physical addresses and actual hardware memory storage locations of data in memory cells, allowing the resources of the processor to be used for other computing tasks.

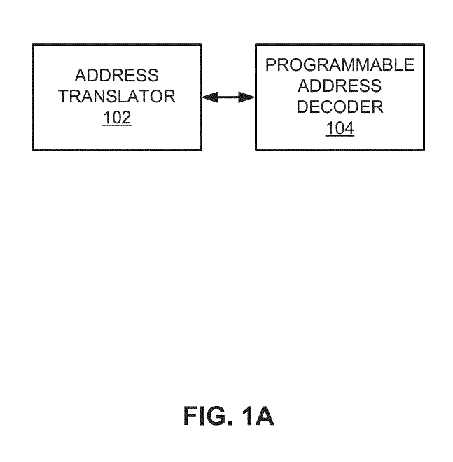

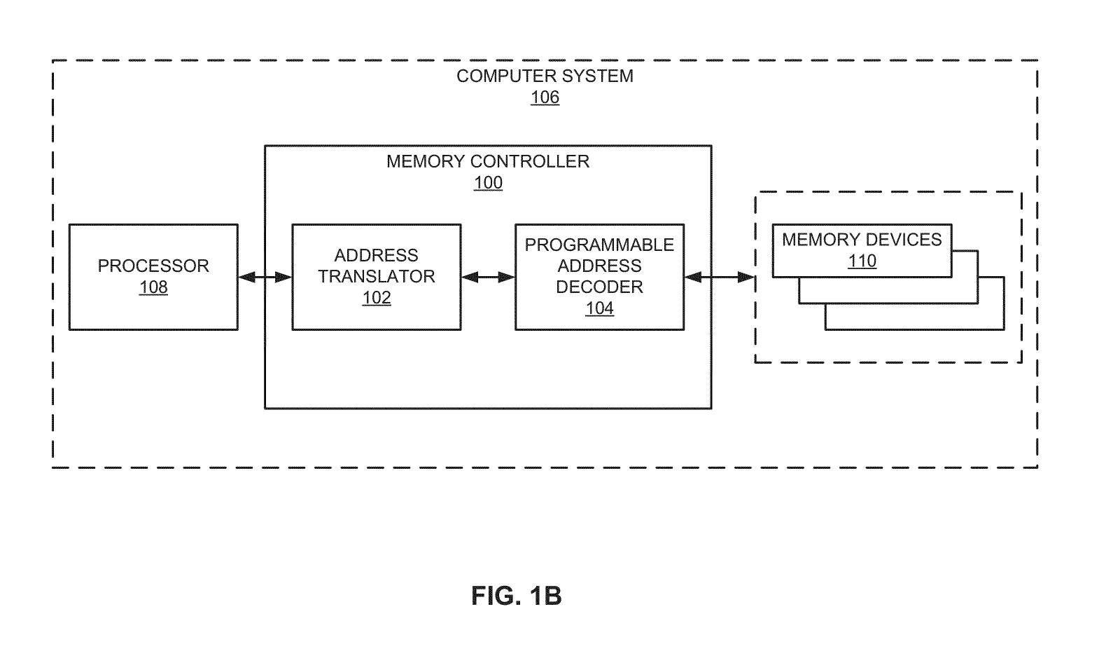

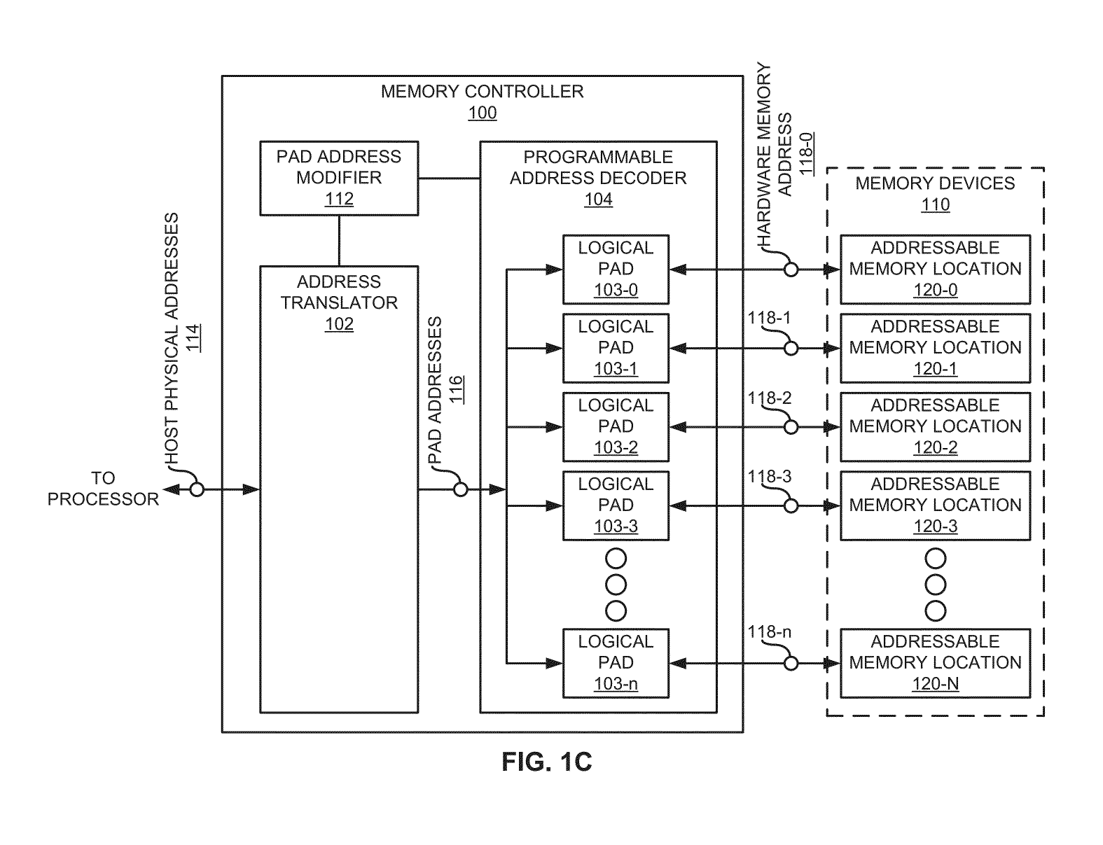

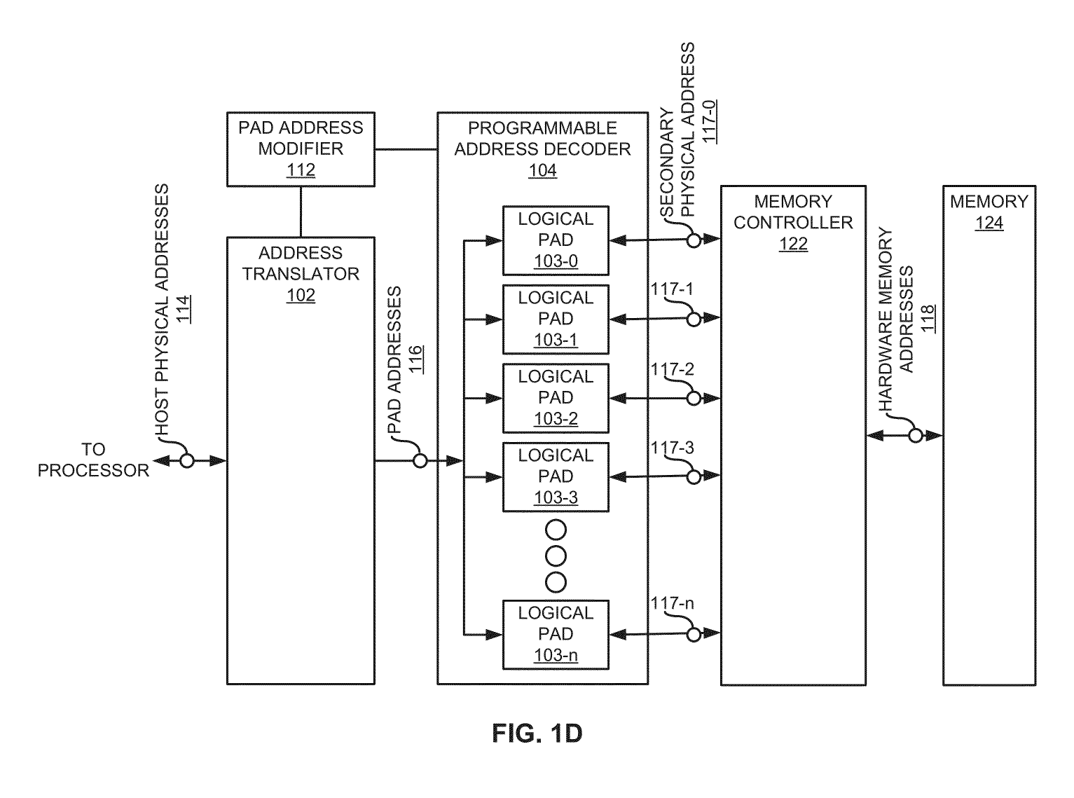

FIG. 1A is a block diagram of an example address translator 102 and an example programmable address decoder (PAD) 104 constructed in accordance with the teachings of this disclosure.

In FIG. 1B, the address translator 102 and the PAD 104 are shown in an example memory controller 100 of an example computer system 106 constructed in accordance with the teachings of this disclosure.

In the example computer system 106, the memory controller 100 is communicatively coupled between a processor 108 (e.g., a hardware processor) and an array of memory devices 110. In the illustrated example, the processor 108 executes instructions of one or more computer programs. The example processor 108 communicates with the example memory controller 100 to perform memory accesses and to instruct the memory controller 100 to perform other programmable operations discussed below. Although the example memory controller 100 is shown separate from the example processor 108, in other examples the memory controller 100 may be located in the processor 108, in a memory module of the computer system 106, or co-located with memory devices 110.

The example memory devices 110 store bits of data in memory bit cells. In the illustrated example, the memory bit cells can be accessed in a big length corresponding to an addressable data width (e.g., 8 bits, 16 bits, 32 bits, 64 bits, 128 bits, etc.) of the memory devices 110. In some examples, the memory controller 100 operates on data blocks larger than the addressable data width (e.g., 1 KB, 4 KB, 1 MB, etc.). In the illustrated example, the memory devices 110 are random access memory (RAM) devices, and an addressable data width of memory bit cells in the memory devices 110 defines an addressable memory location. In other examples, other types of memory or combinations of different types of memory can be used to implement the memory devices 110. The data width (e.g., 8 bits, 16 bits, 32 bits, 64 bits, 128 bits, etc.) of addressable memory locations is dependent on the specific architecture of the computer system 106 and/or the architecture of the memory devices 110.

The example address translator 102 is provided with logic to interface with the example processor 108. The example address translator 102 is also provided with logic to interface with the example PAD 104. The example address translator 102 receives memory access commands from the example processor 108 including host physical addresses. The example address translator 102 translates the received host physical address to corresponding PAD addresses and provides the translated PAD addresses to the example PAD 104. The example address translator 102 also transmits other information (e.g., commands) to the example PAD 104 as described in further detail below to cause the PAD 104 to perform programmable operations.

The example PAD 104 can be logically represented as an array of logical PADs as illustrated in FIG. 1C. Each logical PAD addresses a different addressable memory location of the example memory devices 110. The example PAD 104 is implemented using reconfigurable or programmable logic (e.g., re-programmable logic circuits) that can be used to implement different logical PADs. Alternatively or additionally, the PAD 104 can be implemented using a data structure such 888 re-configurable look-up table.

FIG. 1C illustrates the PAD 104 of FIGS. 1A and 1B as multiple logical PADs 103 in the example memory controller 100 of FIGS. 1A and 1B. Each logical PAD 103 (represented as logical PADs 103-0 to 103-n) has a corresponding PAD address that addresses one specific addressable memory location 120 (represented as addressable memory locations 120-0 to 120-n) of the memory devices 110. In the illustrated example, to execute a command, the address translator 102 broadcasts (e.g., sends to each logical PAD 103) a translated PAD address 116 to the PAD 104 along with the command. Each logical PAD 103 receiving the translated PAD address 116 performs the operations specified by the command if the command is applicable to the PAD address 116 of the logical PAD 103.

In the illustrated example, a PAD address modifier 112 is provided to change the PAD addresses 116 of the logical PADs 103 to re-map PAD addresses 116 to different hardware memory addresses (represented as hardware memory addresses 118-0 to 118-n). For example, the PAD address modifier 112 may re-program logic circuits and/or a lookup table used to implement the PAD 104. When a PAD address 116 of a logical PAD 103 is changed, the logical PAD 103 still communicates with the same addressable memory location 120 of the example memory devices 110. However, because the example address translator 102 always translates a particular host physical address 114 to a same PAD address 116, and because that same PAD address 116 is re-mapped by the PAD address modifier 112 to a different hardware memory address 118, the PAD 104 decodes the PAD address 116 provided by the address translator 102 to the different hardware memory address 118. In this manner, the PAD address modifier 112 and the PAD 104 change the mappings between host physical addresses 114 and hardware memory addresses 118 corresponding to the different addressable memory locations 120. In some examples, the PAD address modifier 112 is embedded in each logical PAD 103.

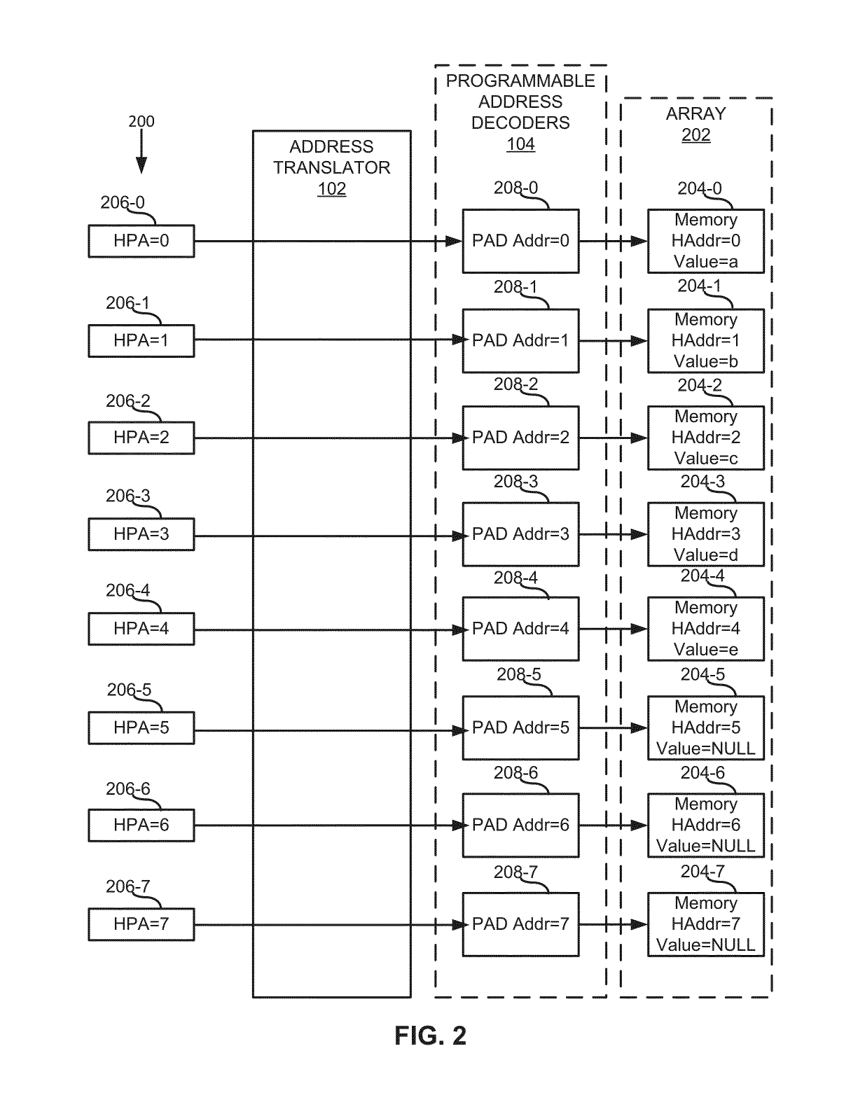

Examples disclosed herein can be used to insert a new value into an array of addressable memory locations without physically moving any values between addressable memory. Examples disclosed herein can also be used to insert values into arrays of addressable memory locations by changing the mapping between host physical addresses and hardware memory addresses. For example, FIG. 2 illustrates an array 202 having eight addressable memory locations 204-0 to 204-7 that store corresponding values {a, b, c, d, e, NULL, NULL, NULL}. The hardware memory addresses (HAddr) for the eight addressable memory locations 204-0 to 204-7 are {0, 1, 2, 3, 4, 5, 6, 7} respectively.

FIG. 2 illustrates eight host physical addresses 206-0 to 206-7 {HPA=0, HPA=1, HPA=2, HPA=3, HPA=4, HPA=5, HPA=6, HPA=7} translated by the example address translator 102 into corresponding PAD addresses (PAD Addr=0-7) (e.g., PAD address 116 of FIG. 1C) of corresponding logical PADs 208-0 to 208-7. In the illustrated example of FIG. 2, the host physical addresses 206-0 to 206-7 are similar or identical to the host physical addresses 114 of FIG. 1C, and the PAD addresses (PAD Addr=0-7) are similar or identical to the PAD addresses 116 of FIG. 1C. Each of the logical PADS 208-0 to 208-7 represents a different one of the logical PADs 103-0 to 103-n of FIG. 1C. In the illustrated example of FIG. 2, host physical address 206-0 (HPA=0) is translated to PAD address 0 (PAD Addr=0) corresponding to logical PAD 208-0, host physical address 206-1 (HPA=1) is translated to PAD address 1 (PAD Addr=1) corresponding to logical PAD 208-1, host physical address 206-2 (HPA=2) is translated to PAD address 2 (PAD Addr=2) corresponding to logical PAD 208-2, host physical address 206-3 (HPA=3) is translated to PAD address 3 (PAD Addr=3) corresponding to logical PAD 208-3, host physical address 206-4 (HPA=4) is translated to PAD address 4 (PAD Addr=4) corresponding to logical PAD 208-4, host physical address 206-5 (HPA=5) is translated to PAD address 5 (PAD Addr=5) corresponding to logical PAD 208-5, host physical address 206-6 (HPA=6) is translated to PAD address 6 (PAD Addr=6) corresponding to logical PAD 208-6 and host physical address 206-7 (HPA=7) is translated to PAD address 7 (PAD Addr=7) corresponding to logical PAD 208-7.

Each of these PAD addresses (PAD addr=0-7) is decoded to a hardware memory address (e.g., the hardware memory addresses 118-0 to 118-n of FIG. 1C) of a corresponding addressable memory location 204-0 to 204-7 as shown in FIG. 2. In the illustrated example of FIG. 2, the PAD 104 decodes PAD address 0 (PAD Addr=0) of the logical PAD 208-0 to addressable memory location 204-0 (HAddr=0), the PAD 104 decodes PAD address 1 (PAD Addr=1) of the logical PAD 208-1 to addressable memory location 204-1 (HAddr=1), the PAD 104 decodes PAD address 2 (PAD Addr=2) of the logical PAD 208-2 to addressable memory location 204-2 (HAddr=2), the PAD 104 decodes PAD address 3 (PAD Addr=3) of the logical PAD 208-3 to addressable memory location 204-3 (HAddr=3), the PAD 104 decodes PAD address 4 (PAD Addr=4) of the logical PAD 208-4 to addressable memory location 204-4 (HAddr=4), the PAD 104 decodes PAD address 5 (PAD Addr=5) of the logical PAD 208-5 to addressable memory location 204-5 (HAddr=5), the PAD 104 decodes PAD address 6 (PAD Addr=6) of the logical PAD 208-6 to addressable memory location 204-6 (HAddr=6) and the PAD 104 decodes PAD address 7 (PAD Addr=7) of the logical PAD 208-7 to addressable memory location 204-7 (HAddr=7).

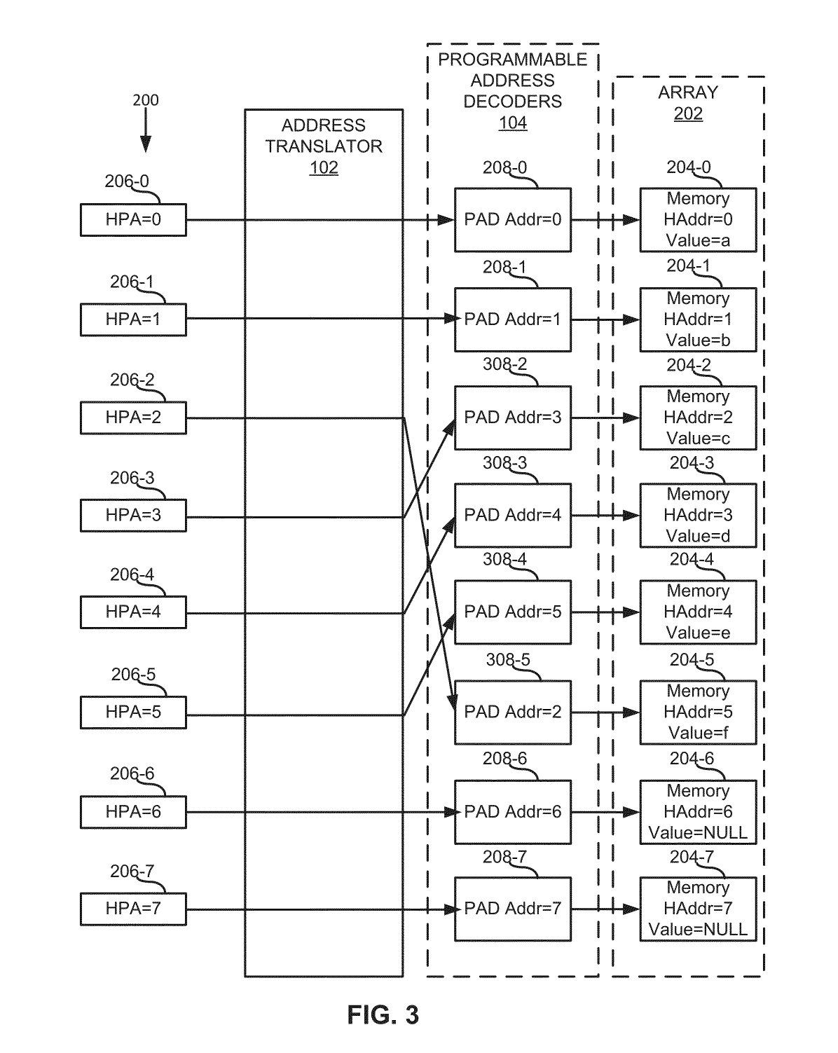

FIG. 3 illustrates the translation of the eight host physical addresses 306-0 to 306-7 of FIG. 2 to PAD addresses (PAD Addr=0-7) and the decoding of the PAD addresses (PAD Addr=0-7) of FIG. 2 into hardware memory addresses (HAddr=0-7) after the example PAD address modifier 112 changes the PAD addresses of four of the logical PADs 103. Specifically, the example PAD address modifier 112 changes the PAD address of logical PAD 208-2 of FIG. 2 to a new logical PAD 308-2 corresponding to PAD Addr=3, the PAD address of logical PAD 208-3 of FIG. 2 to a new logical PAD 308-3 corresponding to PAD Addr=4, the PAD address of logical PAD 208-4 of FIG. 2 to a new logical PAD 308-5 corresponding to PAD Addr=5 and the PAD address of logical PAD 208-5 of FIG. 2 to a new logical PAD 308-5 corresponding to PAD Addr=2. In the illustrated example of FIG. 3, logical PADs 308-2 to 308-5 represent different logical PADs resulting from the above PAD address changes made by the example PAD address modifier 112.

In the illustrated example of FIG. 3, host physical address 206-0 (HPA=0) is translated to PAD address 0 (PAD Addr=0), which still corresponds to logical PAD 208-0, host physical address 206-1 (HPA=1) is translated to PAD address 1 (PAD Addr=1), which still corresponds to logical PAD 208-1, host physical address 206-6 (HPA=6) is translated to PAD address 6 (PAD Addr=6), which still corresponds to logical PAD 208-6, host physical address 206-7 (HPA=7) is translated to PAD address 7 (PAD Addr=7), which still corresponds to logical PAD 208-7.

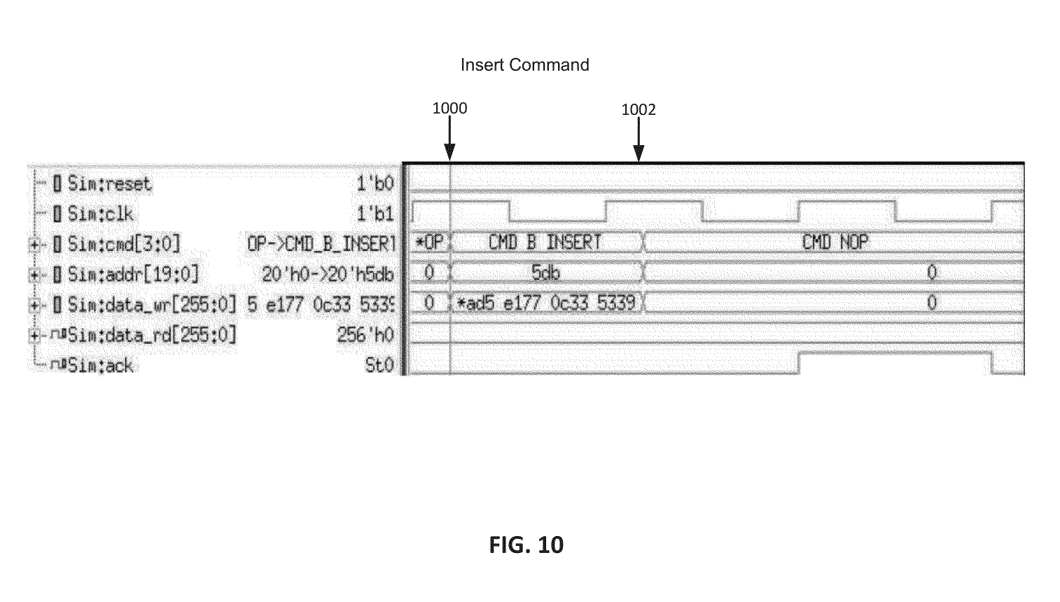

In addition, each of the PAD addresses (PAD Addr=0-7) is decoded to a hardware memory address (HAddr=0-7) (e.g., the hardware memory addresses 118-0 to 118-n of FIG. 10) of a corresponding addressable memory location 204-0 to 204-7 as shown in FIG. 3. In the illustrated example of FIG. 3, the PAD 104 decodes PAD address 0 (PAD Addr=0) of the logical PAD 208-0 to addressable memory location 204-0 (HAddr=0), the PAD 104 decodes PAD address 1 (PAD Addr=1) of the logical PAD 208-1 to addressable memory location 204-1 (HAddr=1), the PAD 104 decodes PAD address 2 (PAD Addr=2) of the logical PAD 308-5 to addressable memory location 204-5 (HAddr=5), the PAD 104 decodes PAD address 3 (PAD Addr=3) of the logical PAD 308-2 to addressable memory location 204-2 (HAddr=2), the PAD 104 decodes PAD address 4 (PAD Addr=4) of the logical PAD 308-3 to addressable memory location 204-3 (HAddr=3), the PAD 104 decodes PAD address 5 (PAD Addr=5) of the logical PAD 308-4 to addressable memory location 204-4 (HAddr=4), the PAD 104 decodes PAD address 6 (PAD Addr=6) of the logical PAD 208-6 to addressable memory location 204-6 (HAddr=6) and the PAD 104 decodes PAD address 7 (PAD Addr=7) of the logical PAD 208-7 to addressable memory location 204-7 (HAddr=7).

In addition to the modified memory mapping above, the memory controller 100 of FIGS. 1B and 1C inserts the value ‘f’ into addressable memory location 204-5 (HAddr=5) corresponding to logical PAD 308-5 (PAD Addr=2). Using operations similar or identical to the above described operations, when a processor requests to read data in host physical addresses 0, 1, 2, 3, 4 and 5, the returned values are ‘a’, ‘b’, ‘f’, ‘c’, and ‘e’, respectively. Examples disclosed herein accomplish this result using relatively few or no data accesses to copy data between addressable memory locations, using relatively few or no memory management resources from a processor, and performs the requested data access operation (e.g., insert the value ‘f’) in relatively less time than used by prior memory controllers.

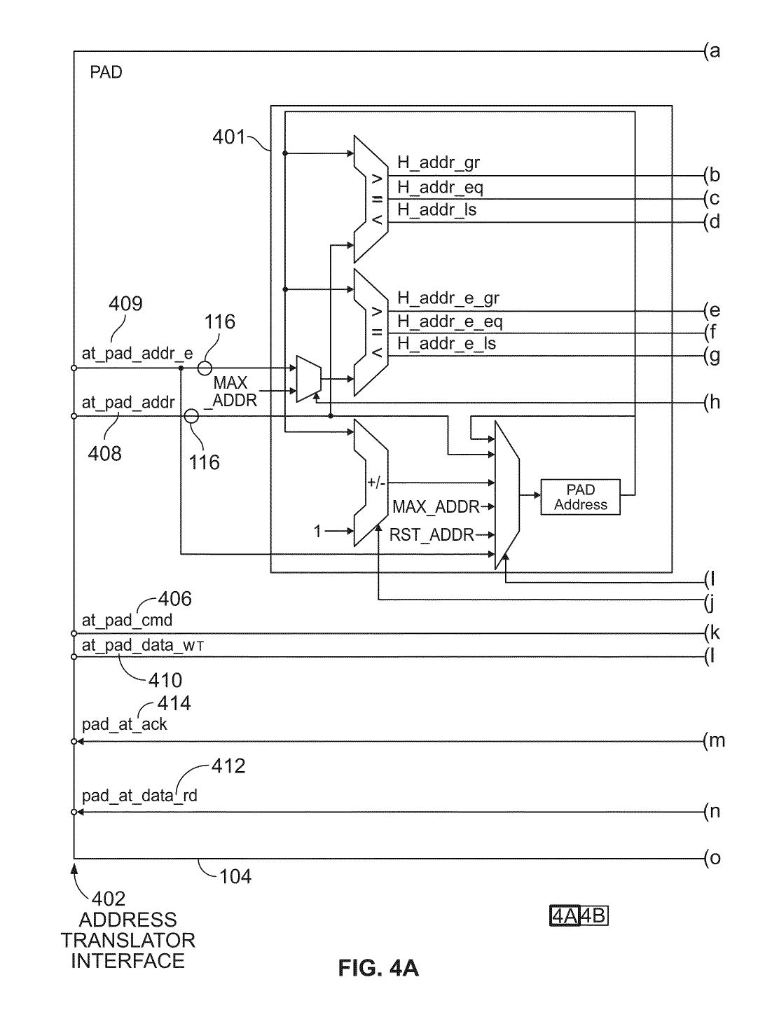

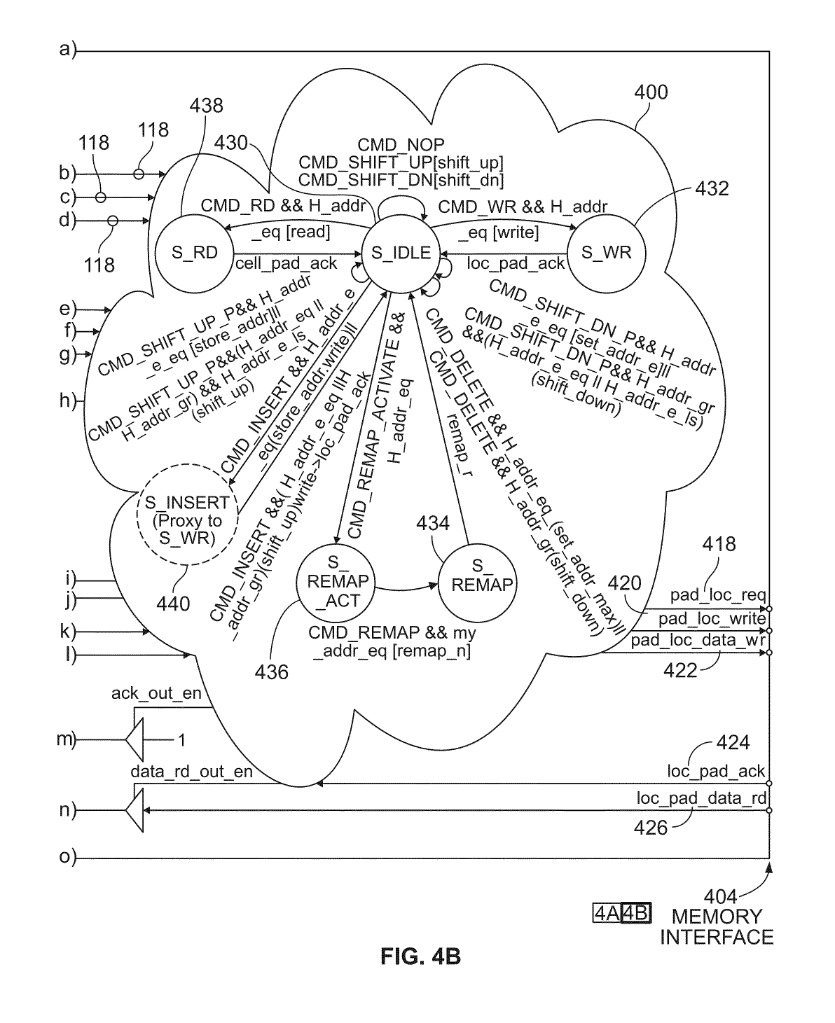

FIGS. 4A and 4B illustrate an example state diagram 400 and an example logic circuit 401 that are used to implement the logical PADs 103 of FIGS. 1C, 2 and 3. In the illustrated example, the logic circuit 401 decodes a PAD address 116 to a hardware memory address 118. In the illustrated example, the PAD 104 is provided with an example address translator interface 402 (e.g., to communicate with the address translator 102 of FIGS. 1A-1D) and example memory interface 404 (e.g., to communicate with the memory devices 110 of FIGS. 1A-1C and/or with the memory controller 122 of FIG. 1D). The example address translator interface 402 includes command lines 406 (at_pad_cmd), address lines (e.g., start address lines) 408 (at_pad_addr), subset end address lines 409 (at₁₃ pad_addr_e), data write lines 410 (at_pad_data_wr), data read lines 412 (pad_ad_data_rd) and an acknowledge line 414 (pad_at_ack).

The example memory interface 404 includes memory address lines 418 (pad_loc_req), memory write lines 420 (pad_loc_write), memory data write lines 422 (pad_loc_data_wr), a memory acknowledge line 424 (loc_pad_ack) and memory data read lines 426 (loc_pad_data_rd).

The command lines 406 carry commands processed by the example PAD 104. In the example of FIGS. 4A and 4B, example commands are Nop, Write, Read, Shift Up, Shift Down, Remap Activate, Remap, Insert, Delete, Partial Shift Up, and Partial Shift Down. However, other commands may also be implemented in addition to or instead of the example commands of FIGS. 4A and 4B. The Nop, Shift Up, Shift Down, Insert, Delete, Partial Shift Up, and Partial Shift Down commands are multi-logical PAD commands, which means that they are directed to multiple example logical PADs 103 (FIGS. 1C, 2 and 3). The Read, Write, Remap Activate and Remap commands are single-logical PAD commands, which means that they are only directed to select ones of the example logical PADs 103. These commands are discussed in further detail below.

The address lines 408 carry PAD addresses 116. Single-logical PAD commands are accompanied by an address on the address lines 408 specifying the PAD address of a logical PAD 103 that is the target of the command. After receiving a host physical address from the example processor 108, the example address translator 102 translates the host physical address to a PAD address and sends this translated PAD address on the address lines 408 to the example PAD 104.

The subset end address lines 409 carry PAD addresses 116 corresponding to subset end addresses used for the partial shift up and partial shift down commands. When the example processor 108 sends a partial shift up or partial shift down command, the processor 108 also specifies a host physical address and a length. The length corresponds to the number of PAD addresses 116 in a subset of PAD addresses 116 that are to be shifted up or shifted down. After receiving a host physical address and a length from the example processor 108, the example address translator 102 translates the host physical address to a PAD address and sends this translated PAD address on the address lines 408 to the example PAD 104. The example address translator 102 also determines a subset end PAD address corresponding to the last address in the subset of PAD addresses 116 to be included in the shift up or shift down command by adding the length to the translated PAD address and subtracting one. The example address translator then sends this subset end PAD address on the subset end address lines 409 to the example PAD 104.

The data write lines 410 carry data to be written to an example memory device 110 based on a corresponding write or insert command. The data read lines 412 carry data that includes data read from an example memory device 110 based on a corresponding read command. The acknowledge line 414 carries an acknowledge signal returned by an example logical PAD 103 after the logical PAD 103 performs a write, read, insert or remap command. The acknowledge signal on the acknowledge line 414 confirms that the operations prompted by the write, read, insert or remap command are complete.

The Nop command (CMD_NOP) is a command for no operation, and causes the example PAD 104 to not perform an operation. As shown in the state diagram 400 of FIG. 4B, the CMD_NOP causes the example PAD 104 to remain in an idle state (S_IDLE) 430. The Nop command is used when no other command has been specified.

The write command (CMD_WR) is used to write data to an example memory device 110. When the example processor 108 writes data to an example addressable memory location 120, the processor 108 specifies a host physical address as well as a data value to be written to an addressable memory location 120 corresponding to that host physical address. The example address translator 102 translates the specified host physical address to a PAD address. The example address translator 102 then sends the write command (CMD_WR), the translated PAD address and the data to be written to the logical PAD 103 that has the translated PAD address. The targeted logical PAD 103 then decodes the PAD address to a hardware memory address and writes the data to the corresponding addressable memory location 120 at the hardware memory address. All other logical PADs 103 simply ignore the command because the translated PAD address is not decoded to their PAD address.

In the example of FIG. 4B, the state machine 400 transitions from the idle state (S_IDLE) 430 to a write state (S_WR) 532 when the PAD 104 sends the write command and the decoded hardware memory address (CMD_WR && H_addr_eq) to the corresponding addressable memory location 120. The example state machine 400 then transitions from the write state (S_WR) 432 back to the idle state (S_IDLE) 430 when the PAD 104 returns an acknowledge signal on the acknowledge line 414 (loc_pad_ack).

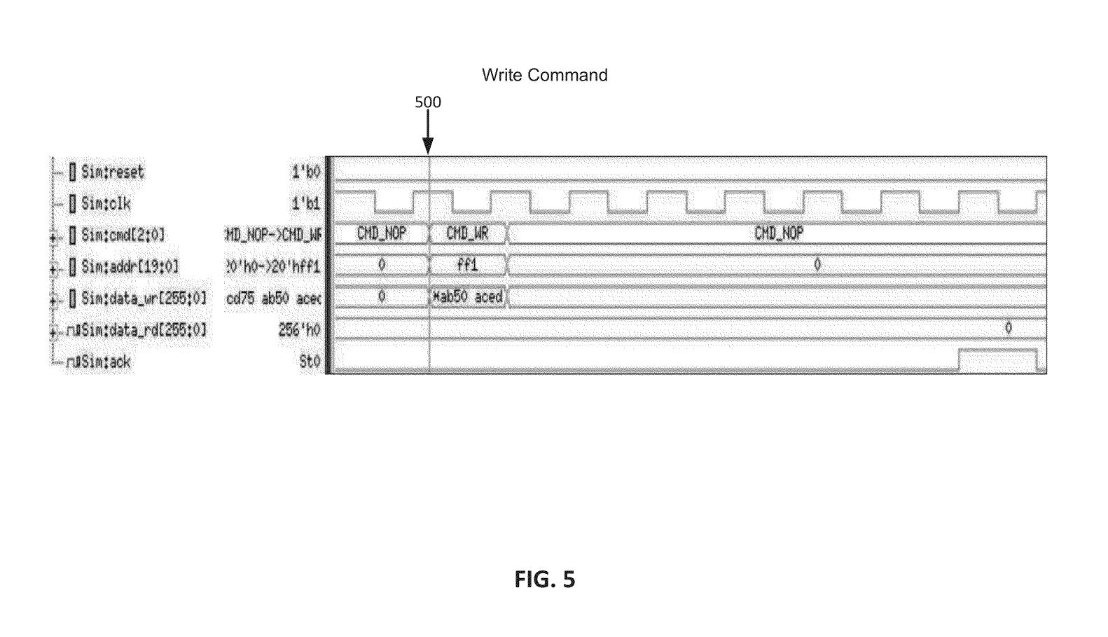

FIG. 5 shows a timing diagram for a write command (CMD _WR). On a first clock cycle 500, the address translator 102 (FIGS. 1A-1C) communicates the write command (CMD_WR) on the command lines 506 (at_pad_cmd), the address translator 102 communicates a PAD address (ff1) on the address lines 408 (at_pad_addr) and the address translator 102 communicates data (#ab50 aced) on the data write lines 410 (at_pad_wr). After the data is written to a corresponding example memory device 110 by the target example logical PAD 103, the logical PAD 103 returns an acknowledge signal on the acknowledge line 414 (loc_pad_ack).

Returning to FIG. 4B, the read command (CMD_RD) is used to read data from an example memory device 110. When the example processor 108 reads data from an example addressable memory location 120, the processor 108 specifies a host physical address where data is to be read from. The example address translator 102 translates the specified host physical address (e.g., a host physical address 114 of FIGS. 1C and 1D) to a PAD address (e.g., a PAD address 116 of FIGS. 1C and 1D). The example address translator 102 then sends the read command (CMD_RD) and the translated PAD address to the logical PAD 103 that has the translated PAD address. The targeted logical PAD 103 then decodes the PAD address to a hardware memory address (e.g., a hardware memory address 118 of FIG. 1C) and reads the data from the corresponding addressable memory location 120 at the hardware memory address. All other logical PADs 103 simply ignore the command because the translated PAD address is not decoded to their PAD address.

In the example of FIG. 4B, the state machine 400 transitions from the idle state (S_IDLE) 430 to a read state (S_RD) 438 when the PAD 104 sends the read command and the decoded hardware memory address (CMD_RD && H_addr_eq) to the corresponding addressable memory location 120. The example state machine 400 then transitions from the read state (S_RD) 438 back to the idle state (S_IDLE) 430 when the PAD 104 returns an acknowledge signal on the acknowledge line 414 (loc_pad_ack).

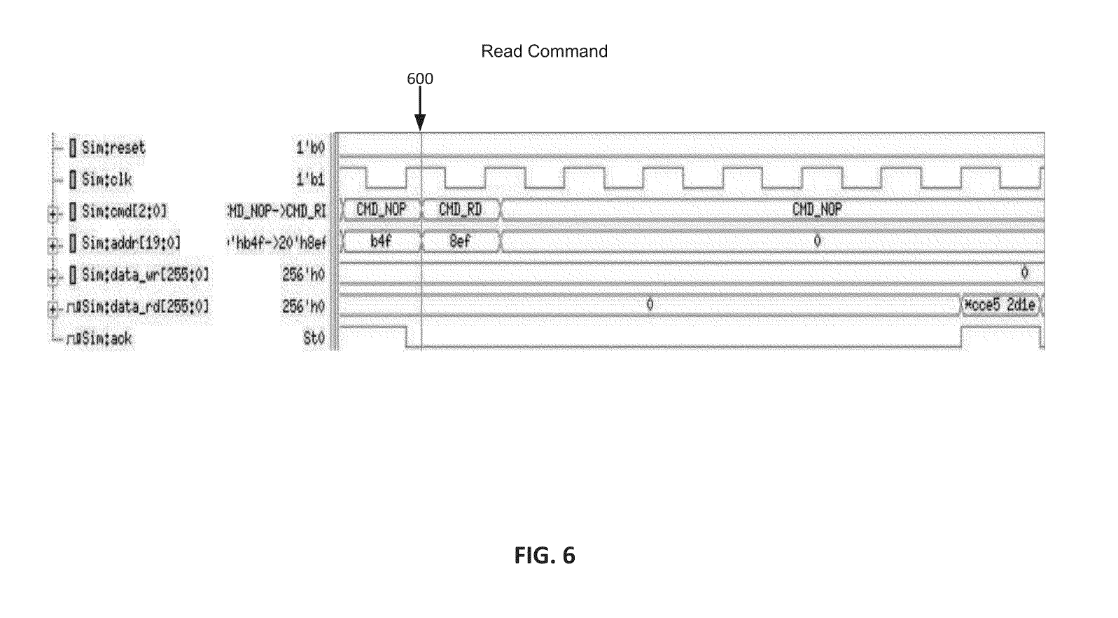

FIG. 6 shows a timing diagram for the read command (CMD_RD). On a first clock cycle 600, the address translator 102 (FIGS. 1A-1C) communicates the read command (CMD_RD) on the command lines 406 (at_pad_cmd) and the address translator 102 communicates a PAD address (8ef) on the address lines 408 (at_pad_addr). After the data is read from a corresponding example memory device 110 by the target example logical PAD 103, the logical PAD 103 returns an acknowledge signal on the acknowledge line 414 (loc_pad_ack).

Returning to FIG. 4B, the shift up command (CMD_SHIFT_UP) is used to shift up the PAD address (e.g., the PAD address 116 of FIGS. 1C and 1D) of all logical PADs 103. To execute a shift up, the example address translator 102 sends the shift up command (CMD_SHIFT_UP) to all logical PADs 103. Each logical PAD 103 then increments its PAD address 116 by one. In the illustrated example, the shift up command (CMD_SHIFT_UP) supports wrapping, wherein upon receiving the shift up command (CMD_SHIFT_UP), the logical PAD 103 with the highest PAD address sets its PAD address to the lowest PAD address. As shown in the state diagram 400 of FIG. 5B, the CMD_SHIFT_UP causes the example PAD 104 to remain in an idle state (S_IDLE) 430. This is a single cycle operation and because no new data is stored, no acknowledge is sent.

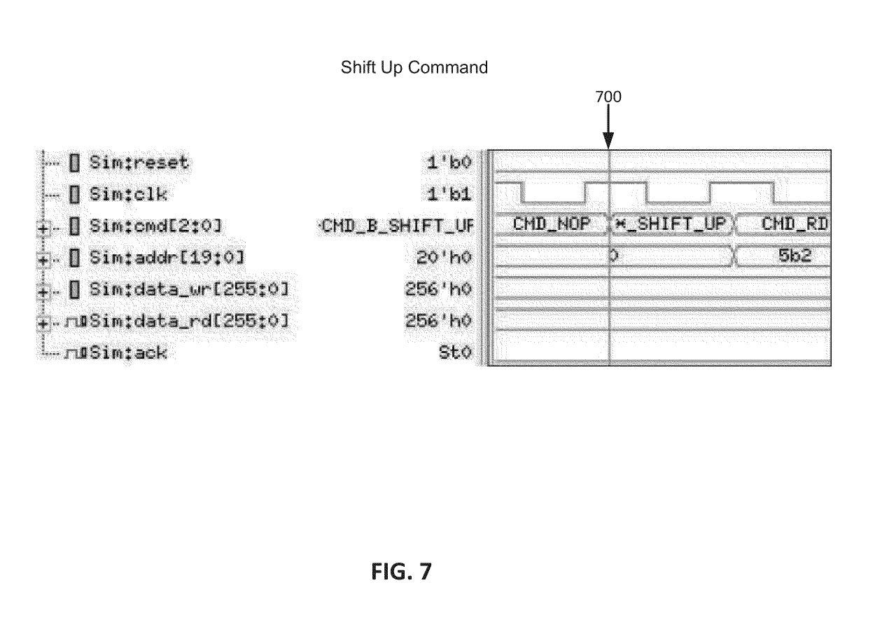

FIG. 7 shows a timing diagram for a shift up command (CMD_SHIFT_UP). On a first clock cycle 700, the address translator 102 (FIGS. 1A-1C) communicates the shift up command (CMD_SHIFT_UP) on the command lines 506 (at_pad_cmd).

Returning to FIG. 4B, the shift down command (CMD_SHIFT_DN) is used to shift down the PAD address 116 of all logical PADs 103. To execute a shift down, the example address translator 102 sends the shift down command (CMD_SHIFT_DN) to all logical PADs 103. Each logical PAD 103 then decrements its PAD address 116 by one. In the illustrated example, the shift down command (CMD_SHIFT_DN) supports wrapping, wherein upon receiving the shift down command (CMD_SHIFT_DN), the logical PAD 103 with the lowest PAD address sets its PAD address to the highest PAD address. As shown in the state diagram 400 of FIG. 4B, the CMD_SHIFT_DN causes the example PAD 104 to remain in an idle state (S_IDLE) 430. This is a single cycle operation and because no new data is stored, no acknowledge is sent.

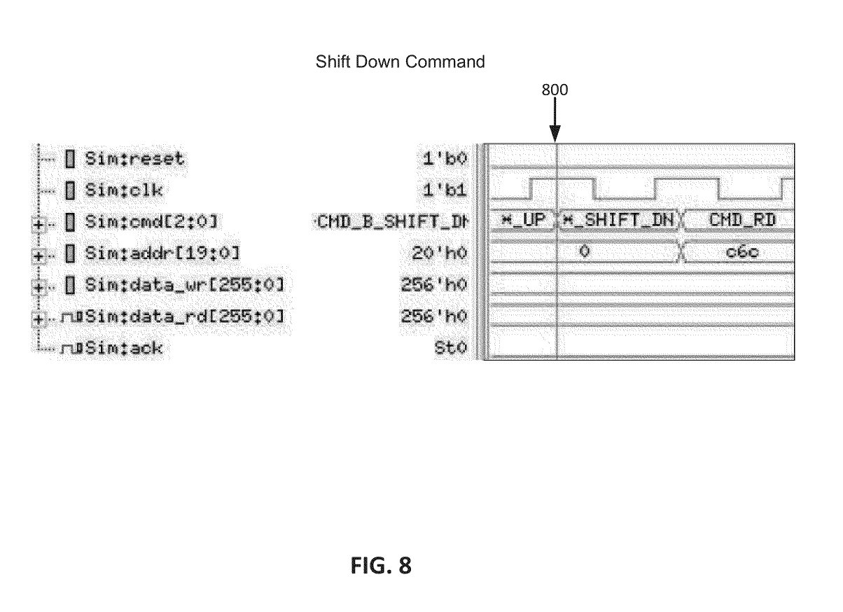

FIG. 8 shows a timing diagram for a shift down command (CMD_SHIFT_DN). On a first clock cycle 800, the address translator 102 (FIGS. 1A-1C) communicates the shift down command (CMD_SHIFT_DN) on the command lines 406 (at_pad_cmd).

Returning to FIG. 4B, the remap activate command (CMD_REMAP_ACTIVATE) and the remap command (CMD_REMAP) are used to remap the PAD addresses 116 of two or more logical PADs 103. To execute a remap activate command (CMD_REMAP_ACTIVATE), the processor specifies two or more host physical addresses 114 to be remapped. The example address translator 102 translates the specified host physical addresses 114 to PAD addresses 116. The example address translator 102 then sends the remap activate command (CMD_REMAP_ACTIVATE) and the translated PAD addresses 116 to the logical PADs 103 that have the translated PAD addresses 116. The targeted logical PADs 103 then decode the PAD addresses 116 to hardware memory addresses 118 and a remap ready flag is set on the logical PAD 103. The remap ready flag indicates that the example logical PADs 103 are in remap mode to avoid having more than one element at a given time with the same PAD address 116 after a remap.

In the example of FIG. 4B, the state machine 400 transitions from the idle state (S_IDLE) 430 to a remap activate state (S_REMAP_ACT) 436 when the PAD 104 sends the remap activate command and the decoded hardware memory addresses (CMD_REMAP_ACTIVATE && H_Addr_eq).

After executing a remap activate command (CMD_REMAP_ACTIVATE), a remap command (CMD_REMAP) is executed. To execute a remap command (CMD_REMAP), the processor specifies a first host physical address 114 to be remapped followed by a second host physical address 114 to which to remap. The example address translator 102 translates the specified host physical addresses 114 to corresponding PAD addresses 116. The example address translator 102 then sends the remap command (CMD_REMAP) and the translated PAD addresses 116 to the logical PADs 103 that have the translated PAD addresses 116. The targeted logical PADs 103 then decode the PAD addresses 116 to hardware memory addresses 118 and remaps the first translated PAD address 116 corresponding to the first processor specified host physical address 114 to the second translated PAD address 116 corresponding to the second processor specified host physical address 114.

In the example of FIG. 4B, the state machine 400 transitions from the remap activate state (S_REMAP_ACT) 436 to a remap state (S_REMAP) 434 when the PAD 104 sends the remap command and the decoded hardware memory addresses (CMD_REMAP && H_addr_eq).

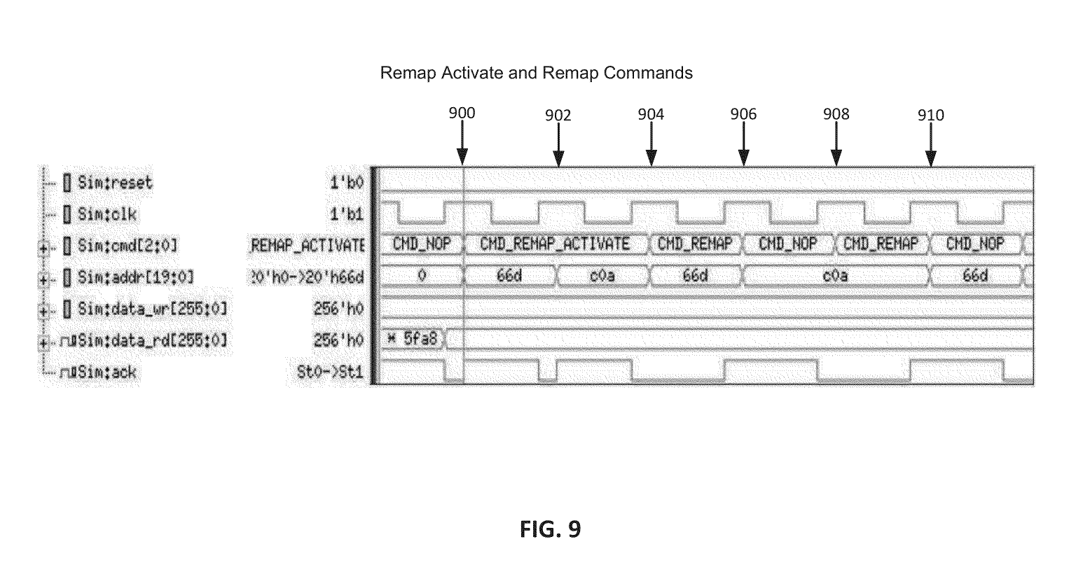

FIG. 9 shows a timing diagram for a remap activate command (CMD_REMAP_ACTIVATE) and a remap command (CMD_REMAP). On a first clock cycle 900, the address translator 102 (FIGS. 1A-1C) communicates the remap activate command (CMD_REMAP_ACTIVATE) on the command lines 406 (at_pad_cmd), and the address translator 102 communicates a first PAD address (66d) on the address lines 408 (at_pad_addr). On a second clock cycle 902, the address translator 102 continues to communicate the remap activate command (CMD_REMAP_ACTIVATE) on the command lines 406 (at_pad_cmd), and the address translator 102 communicates a second PAD address (c0a) on the address lines 408 (at_pad_addr). On a third clock cycle 904, the address translator 102 communicates the remap (CMD_REMAP) command on the command lines 406 (at_pad_cmd), and the address translator 102 communicates the first PAD address (66d) on the address lines 408 (at_pad_addr). On a fourth clock cycle 906, the address translator 102 communicates the Nop command (CMD_NOP) on the command lines 406 (at_pad_cmd), and the address translator 102 communicates the second PAD address (c0a) on the address lines 408 (at_pad_addr). On a fifth clock cycle 906, the address translator 102 communicates the remap command (CMD_REMAP) on the command lines 406 (at_pad_cmd), and the address translator 102 communicates the second PAD address (c0a) on the address lines 408 (at_pad_addr). On a sixth clock cycle 908, the address translator 102 communicates the Nop command (CMD_NOP) on the command lines 406 (at_pad_cmd), and the address translator 102 communicates the first PAD address (66d) on the address lines 408 (at_pad_addr). After a PAD address 116 of a logical PAD 103 is changed, the logical PAD 103 returns an acknowledge signal on the acknowledge line 414 (loc_pad_ack) to indicate a successful completion of the remap operation.

Returning to FIG. 4B, the insert command (CMD_INSERT) is used to insert a data value at a given addressable memory location 120 in an array of addressable memory locations. To insert a value into an addressable memory location 120, the example processor 108 transmits the insert command (CMD_INSERT) along with the data value to be inserted and the host physical address 114 where the insertion is to be made. The example address translator 102 translates the specified host physical 114 address to the corresponding PAD address 116 and transmits the translated PAD address 116, the data value and the insert command (CMD_INSERT) to each of the logical PADs 103.

When a logical PAD 103 receives the insert command (CMD_INSERT), if the PAD address 116 of the logical PAD 103 is less than the specified PAD address 116, then the logical PAD 103 does nothing. If the PAD address 116 of the logical PAD 103 receiving the insert command (CMD_INSERT) is the last PAD address 116 of the array of logical PADs 103, then the logical PAD 103 sets its PAD address 116 to the PAD address 116 accompanying the insert command (CMD_INSERT), and writes the data value accompanying the insert command (CMD_INSERT) to the memory device 110 associated with the logical PAD 103. Otherwise, if the PAD address 116 of the logical PAD 103 receiving the insert command (CMD_INSERT) is greater than or equal to the PAD address 116 accompanying the insert command (CMD_INSERT), the PAD address 116 of the logical PAD 103 is incremented by one.

In the example of FIG. 4B, the state machine 400 transitions from the idle state (S_IDLE) 430 to an insert state (S_INSERT) 440 when the PAD 104 sends the insert command and the decoded hardware address corresponding to the last PAD address 116 of the array of logical PADs 103 (CMD_INSERT && H_addr_e_eq) to the corresponding addressable memory location 120, or when the PAD 104 sends the insert command and a decoded hardware address that is greater than or equal to the corresponding to the specified PAD address 116 (CMD_INSERT && (H_addr_eq) H_addr_gr)) to the corresponding addressable memory location 120. The example state machine 400 then transitions from the insert state (S_INSERT) 440 back to the idle state (S_IDLE) 430 when the PAD 140 returns an acknowledge signal on the acknowledge line 414 (loc_pad_ack).

FIG. 10 shows a timing diagram for the insert command (CMD_INSERT). On a first clock cycle 1000, the address translator 102 (FIGS. 1A-1C) communicates the insert command (CMD_INSERT) on the command lines 406 (at_pad_cmd), the address translator 102 communicates a PAD address (5db) on the address lines 408 (at_pad_addr) and the address translator 102 communicates data (*ad5 e177 0c33 5339) on the data write lines 410 (at_pad_wr). After the data is written by the appropriate logical PAD 103, the logical PAD 103 returns an acknowledge signal on the acknowledge line 414 (loc_pad_ack).

Returning to FIG. 4B, the delete command (CMD_DELETE) is used to remove a data value at a given addressable memory location 120 from an array of addressable memory locations. To delete a value from an addressable memory location 120, the example processor 108 transmits the delete command (CMD_DELETE) along with the host physical address 114 where the deletion is to occur. The example address translator 102 translates the specified host physical address 114 to the corresponding PAD address 116 and transmits the translated PAD address 116 and the delete command (CMD_DELETE) to each of the logical PADs 103.

When a logical PAD 103 receives the delete command (CMD_DELETE), if the PAD address 116 of the logical PAD 103 is less than the specified PAD address 116, then the logical PAD 103 does nothing. If the PAD address 116 of the logical PAD 103 receiving the delete command (CMD_DELETE) is the same as the PAD address 116 accompanying the delete command (CMD_DELETE), then the PAD address 116 of the logical PAD 103 is set to the maximum address in the array of logical PADs 103. Otherwise, if the PAD address 116 of the logical PAD 103 receiving the delete command (CMD_DELETE) is greater than the PAD address 116 accompanying the delete command (CMD_DELETE), the PAD address 116 of the logical PAD 103 is decremented by one. As shown in the state diagram 400 of FIG. 4B, the CMD_DELETE causes the example PAD 104 to remain in an idle state (S_IDLE) 430.

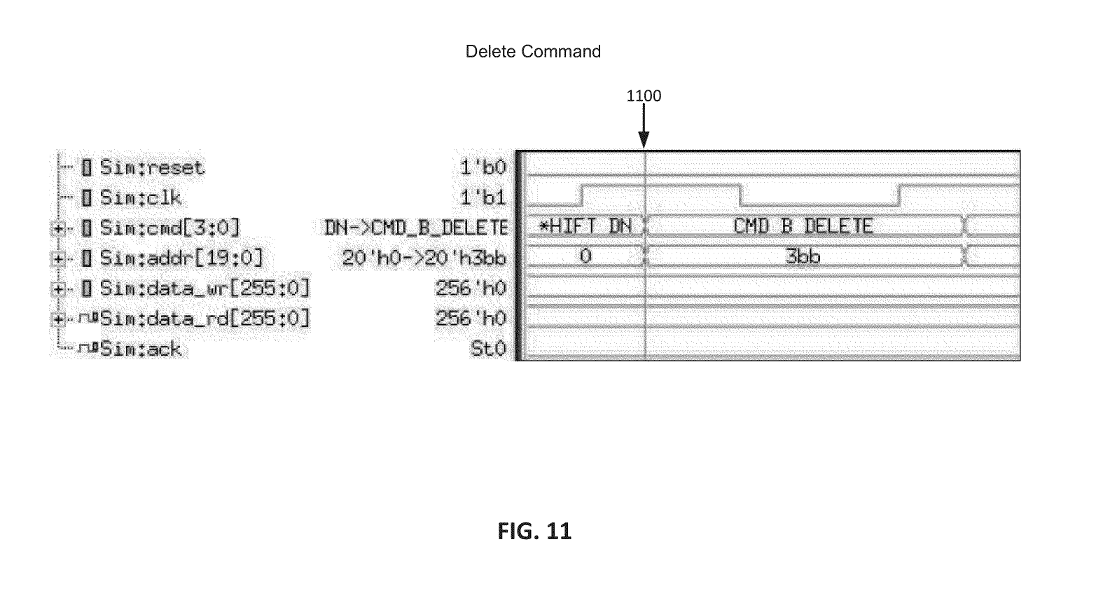

FIG. 11 shows a timing diagram for the delete command (CMD_DELETE). On a first clock cycle 1100, the address translator 102 (FIGS. 1A-1C) communicates the delete command (CMD_DELETE) on the command lines 406 (at_pad_cmd) and the address translator 102 communicates a PAD address (3db) on the address lines 408 (at_pad_addr).

Returning to FIG. 4B, the partial shift up command (CMD_SHIFT_UP_P) is used to shift up the PAD address (e.g., the PAD address 116 of FIGS. 1C and 1D) of a subset of the logical PADs 103. To execute a partial shift up, the example processor 108 specifies a host physical address where the shift up is to begin and a length corresponding to the number of addressable memory locations 120 to be shifted up. The example address translator 102 translates the specified host physical address to a PAD address and determines a subset end PAD address by adding the length to the translated PAD address and subtracting one (e.g., (‘length’+‘translated PAD address’)−1). The example address translator 102 then sends the partial shift up command (CMD_SHIFT_UP_P), the translated PAD address and the determined subset end PAD address to all logical PADs 103.

When a logical PAD 103 receives the partial shift up command (CMD_SHIFT_UP_P), if the PAD address of the logical PAD 103 is less than the specified PAD address or greater than the subset end PAD address, then the logical PAD 103 does nothing. If the PAD address 116 of the logical PAD 103 receiving the partial shift up command (CMD_SHIFT_UP_P) is equal to the subset end PAD address, then the logical PAD 103 sets its PAD address to the specified PAD address 116 of the array of logical PADs 103. If the PAD address 116 of the logical PAD 103 receiving the partial shift up command is greater than or equal to the specified PAD address but less than the determined subset end PAD address, then the logical PAD 103 increments its PAD address by one. As shown in the state diagram 400 of FIG. 4B, the CMD_SHIFT_UP_P causes the example PAD 104 to remain in an idle state (S_IDLE) 430 because it is a single cycle command.

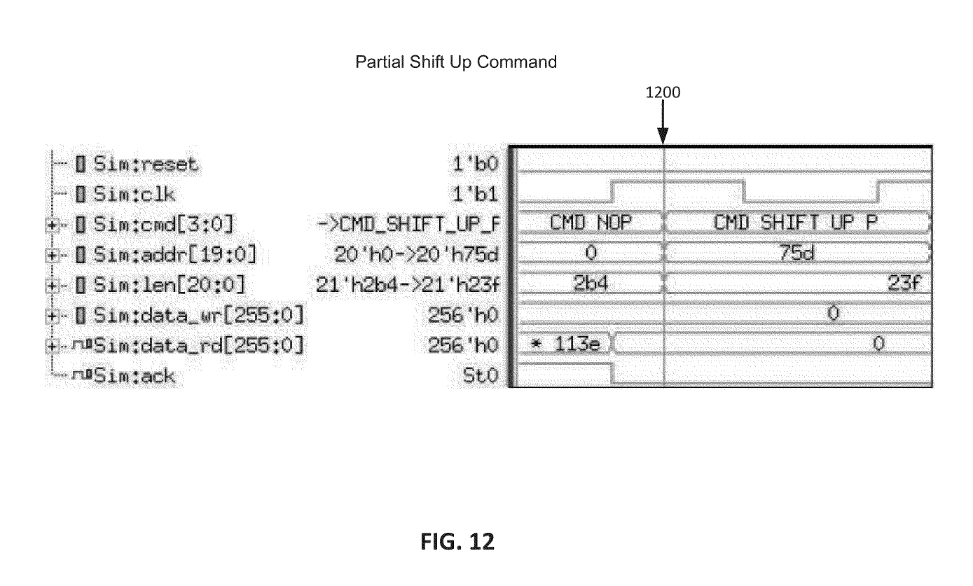

FIG. 12 shows a timing diagram for a partial shift up command (CMD_SHIFT_UP_P). On a first clock cycle 1200, the address translator 102 (FIGS. 1A-1C) communicates the partial shift up command (CMD_SHIFT_UP_P) on the command lines 406 (at_pad_cmd), the address translator 102 communicates an address (75d) on the address lines 408 (at_pad_addr), and the address translator 102 communicates a subset end address (75d+23f−1=99B), based on a length of 23f on the subset end address lines 509 (at_pad_addr_e).

Returning to FIG. 4B, the partial shift down command (CMD_SHIFT_DN_P) is used to shift down the PAD address (e.g., the PAD address 116 of FIGS. 1C and 1D) of a subset of the logical PADs 103. To execute a partial shift down, the example processor 108 specifies a host physical address where the shift down is to begin and a length corresponding to the number of addressable memory locations 120 to be shifted down. The example address translator 102 translates the specified host physical address to a PAD address and determines a subset end PAD address by adding the length to the translated PAD address and subtracting one (e.g., ‘length’+‘translated PAD address’)−1). The example address translator 102 then sends the partial shift down command (CMD_SHIFT_DN_P), the translated PAD address and the determined subset end PAD address to all logical PADs 103.

When a logical PAD 103 receives the partial shift down command (CMD_SHIFT_DN_P), if the PAD address of the logical PAD 103 is less than the specified PAD address or greater than the subset end PAD address, then the logical PAD 103 does nothing. If the PAD address 116 of the logical PAD 103 receiving the partial shift down command (CMD_SHIFT_DN_P) is equal to the specified PAD address, then the logical PAD 103 sets its PAD address to the subset end PAD address. If the PAD address 116 of the logical PAD 103 receiving the partial shift down command is greater than the specified PAD address but less than or equal to the determined subset end PAD address, then the logical PAD 103 decrements its PAD address by one. As shown in the state diagram 400 of FIG. 4B, the CMD_SHIFT_DN_P causes the example PAD 104 to remain in an idle state (S_IDLE) 430, because it is a single cycle command.

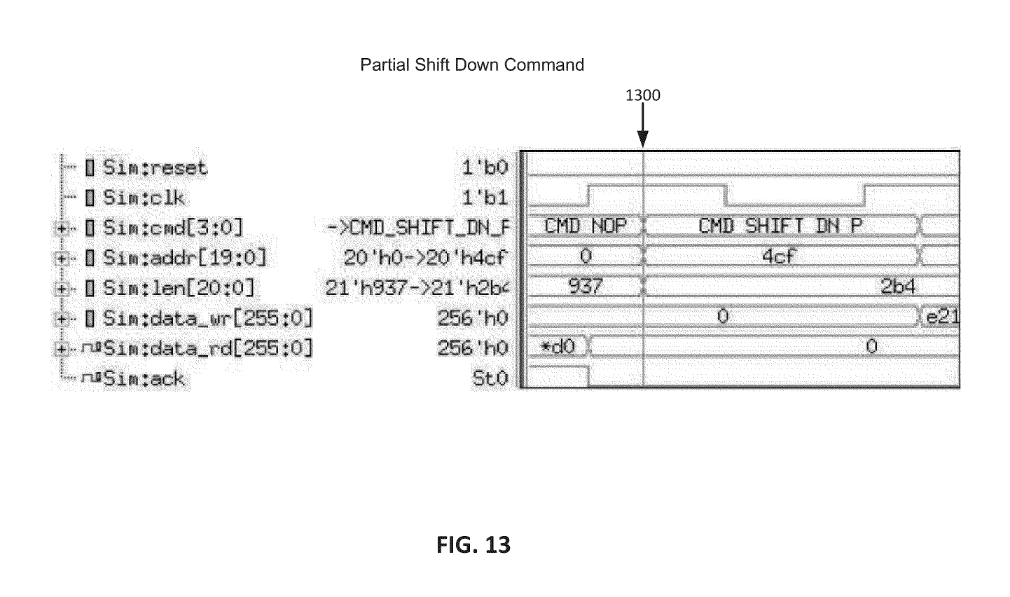

FIG. 13 shows a timing diagram for a partial shift down command (CMD_SHIFT_DN_P). On a first clock cycle 1300, the address translator 102 (FIGS. 1A-1C) communicates the partial shift down command (CMD_SHIFT_DN_P) on the command lines 406 (at_pad_cmd), the address translator 102 communicates an address (4cf+2b4−1=782) on the address lines 408 (at_pad_addr), based on a length of 2b4, and the address translator 102 communicates a subset end address (2b4) on the subset end address lines 409 (at_pad_addr_e).

In addition to the commands specified in FIG. 4B, the example memory controller 100 can be programmed to receive and process other commands that change the mapping between a host physical address and a hardware memory address through the use of PAD addresses.

In the illustrated example, each of the commands described herein are sent by the processor 108 and received by the PAD 104 to offload mapping of physical addresses to the PAD 104 and to increase performance of memory operations by programming the PAD 104 to perform such memory operations. For example, the PAD 104 can reorder address mappings for accessing the example array of memory devices 110 to decrease data moves and copies between addressable memory locations of memory devices. In some examples, the processor 108 and the memory controller 100 can be implemented such that other commands, in addition to the commands described herein, are sent by the processor 108 and received by the memory controller 100 to cause the PAD 104 to change the mapping between the host physical address 114 specified by the processor 108 and the hardware memory addresses 118 of the example memory devices 110.

In the illustrated examples of FIGS. 1B and 1C, the address translator 102, the PAD 104 and the PAD address modifier 112 are located in the memory controller 100. In examples as shown in FIG. 1D, the PAD 104 decodes PAD addresses 116 to secondary physical addresses 117 (117-0 to 117-n) rather than hardware memory addresses 118. In such examples, the address translator 102, the PAD 104 and the PAD address modifier 112 are located external to a memory controller 122. In the illustrated example of FIG. 1D, the PAD 104 sends the decoded secondary physical addresses 117 to the memory controller 122, which decodes the secondary physical addresses 117 to hardware memory addresses 118 in a memory 124 using prior techniques. The example commands and methods disclosed herein in connection with FIGS. 4-25 may be implemented using the example configuration of FIG. 1D. In such examples, the PAD 104 determines the secondary physical addresses 117 of FIG. 1D instead of the hardware memory addresses 118.

While an example manner of implementing the memory controller 100 has been illustrated in FIGS. 1A, 1B, 1C and 1D, one or more of the elements, processes and/or devices illustrated in FIGS. 1A, 1B, 1C and/or 1D may be combined, divided, re-arranged, omitted, eliminated and/or implemented in any other way. Further, the example address translator 102, the example PAD 104, the example PAD address modifier 112, the example memory devices 110 and/or, more generally, the example memory controller 100 of FIGS. 1A, 1B, 1C and/or 1D may be implemented by hardware, software, firmware and/or any combination of hardware, software and/or firmware. Thus, for example, any of the example address translator 102, the example PAD 104, the example PAD address modifier 112, the example memory devices 110 and/or, more generally, the example memory controller 100 of FIGS. 1A, 1B, 1C and/or 1D could be implemented by one or more circuit(s), programmable processor(s), application specific integrated circuit(s) (ASIC(s)), programmable logic device(s) (PLD(s)), microprocessor(s), hardware processor(s), and/or field programmable logic device(s) (FPLD(s)), etc. When any of the system or apparatus claims of this patent are read to cover a purely software and/or firmware implementation, at least one of the example address translator 102, the example PAD 104, the example PAD address modifier 112, the example memory devices 110 and/or, more generally, the example memory controller 100 of FIGS. 1A, 1B, 1C and/or 1D is hereby expressly defined to include a tangible computer readable storage medium such as a memory, DVD, CD, Blu-ray, etc. storing the software and/or firmware. Further still, the example address translator 102, the example PAD 104, the example address translator 102, the example PAD 104, the example PAD address modifier 112, the example memory devices 110 and/or, more generally, the example memory controller 100 of FIGS. 1A, 1B, 1C and/or 1D may include more than one of any or all of the illustrated elements, processes and devices.

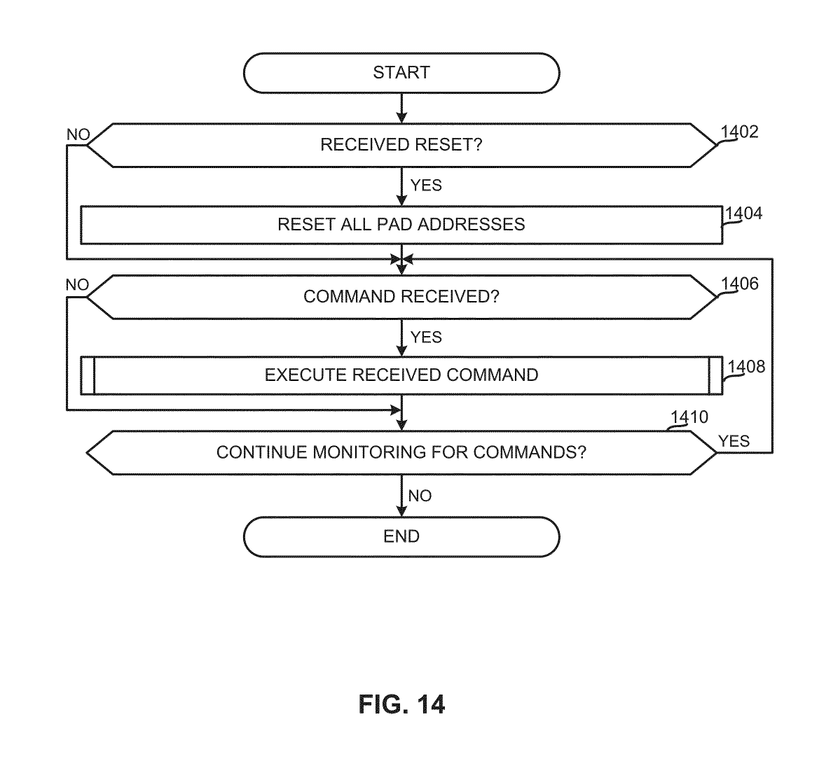

Flowcharts representative of example machine readable instructions for implementing the example address translator 102, the example PAD 104 and the example PAD address modifier 112 of FIGS. 1A, 1B, 1C, 1D, 2, 3 and 4 are shown in FIGS. 14-25. In these examples, the machine readable instructions comprise a program for execution by a processor. The program may be embodied in software stored on a tangible computer readable medium such as a CD-ROM, a floppy disk, a hard drive, a digital versatile disk (DVD), a Blu-ray disk, or a memory associated with the processor, but the entire program and/or parts thereof could alternatively be executed by a device other than the processor and/or embodied in firmware or dedicated hardware. Further, although the example program is described with reference to the flowcharts illustrated in FIGS. 14-25, many other methods of implementing the example address translator 102, the example PAD 104 and the example PAD address modifier 112 may alternatively be used. For example, the order of execution of the blocks may be changed, and/or some of the blocks described may be changed, eliminated, or combined.

As mentioned above, the example processes of FIGS. 14-25 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 14-25 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 14 depicts a flow diagram of an example method to perform commands received at the PAD 104 of FIGS. 1A-1D and 2-3. Initially, the PAD 104 determines whether it has received a reset (block 1402). For example, the processor 108 may issue a reset during a boot process to initialize memory. If the PAD 104 has received a reset (block 1402), the PAD 104 executes the reset by resetting the PAD addresses 116 (FIGS. 1C and 1D) (block 1404) of the example logical PADs 103 (FIGS. 1C and 1D) to the hardware memory addresses 118 of FIG. 1C (or to the secondary physical addresses 117 of FIG. 1D).

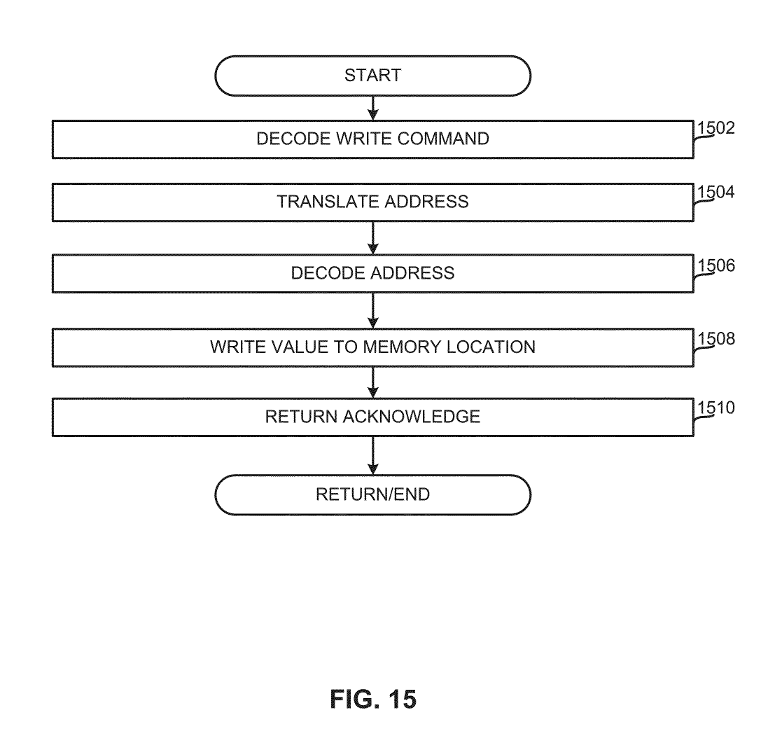

The example PAD 104 then determines whether it has received a command (block 1406). For example, the PAD 104 determines whether it has received a command (e.g., Nop, write, read, shift up, shift down, remap activate, remap, insert, delete, partial shift up, partial shift down) from the processor 108 through the address translator 102. When the example PAD 104 receives a command (block 1406), the PAD 104 executes the command (block 1408) as described above in connection with FIGS. 4-13. Example methods for executing different commands at block 1408 are described below in connection with FIGS. 15-24.

If a command is not received at block 1406, or after executing the received command at block 1408, the PAD 104 determines whether to continue monitoring for commands (block 1410). If the PAD 104 should continue monitoring for commands (block 1410), control returns to block 1406. Otherwise, the example method of FIG. 14 ends.

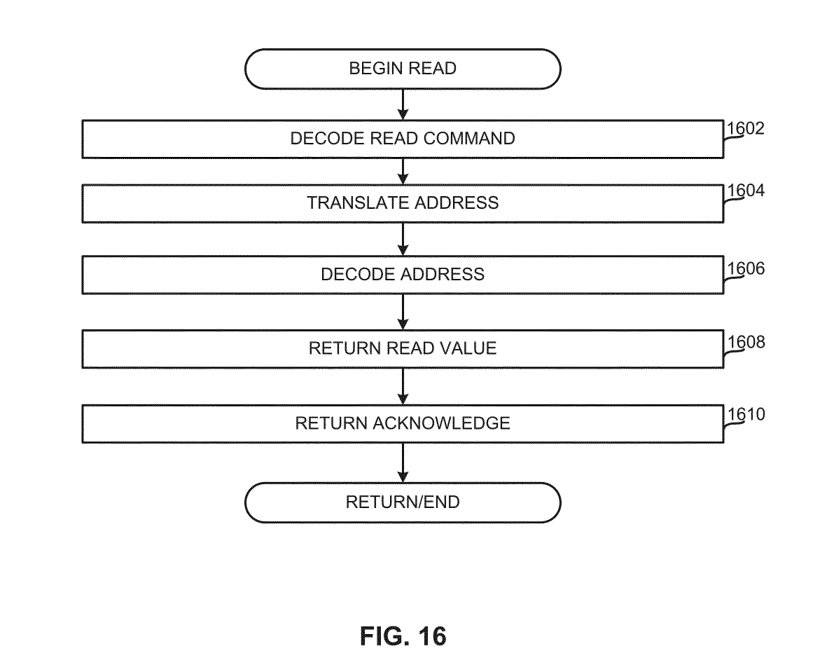

FIG. 15 is a flowchart representative of an example method to execute a write command (CMD_WR) using the example address translator 102 and the example PAD 104 of FIGS. 1A-1D and 2-4. The example method of FIG. 15 may be used to implement block 1408 of FIG. 14 to execute write commands. FIG. 15 begins when the example PAD 104 decodes a write command (block 1502). The example address translator 102 translates a host physical address specified in the write command into a PAD address (block 1504). For example, the address translator 102 may translate a host physical address 114 of FIGS. 1C and 1D into a PAD address 116 of FIGS. 1C and 1D. An example logical PAD 103 (FIGS. 1C and 1D) corresponding to the translated PAD address 116 decodes the PAD address 116 to a hardware memory address 118 (block 1506). For example, the logical PAD 103 can decode the PAD address 116 received from the address translator 102 to a corresponding hardware memory address 118 (FIG. 1C) of an addressable memory location 120 (FIG. 1C). Alternatively, the logical PAD 103 decodes the PAD address 116 to a secondary physical address 117 of FIG. 1D. The example PAD 104 writes the value specified in the received write command to the addressable memory location 120 (block 1508). The example PAD 104 returns an acknowledge communication to the processor 108 (block 1510). The example method of FIG. 16 then returns to a calling process or function such as the example method of FIG. 14, and the example method of FIG. 15 ends.

FIG. 16 is a flowchart representative of an example method to execute a read command (CMD_RD) using the example address translator 102 and the example PAD 104 of FIGS. 1A-1D and 2-4. The example method of FIG. 16 may be used to implement block 1408 of FIG. 14 to execute read commands. FIG. 16 begins when the example PAD 104 decodes a read command (block 1602). The example address translator 102 translates a host physical address specified in the read command into a PAD address (block 1604). For example, the address translator 102 may translate a host physical address 114 of FIGS. 1C and 1D into a PAD address 116 of FIGS. 1C and 1D. An example logical PAD 103 (FIGS. 1C and 1D) corresponding to the translated PAD address decodes the PAD address to a hardware memory address (block 1606). For example, the logical PAD 103 can decode the PAD address 116 received from the address translator 102 to a corresponding hardware memory address 118 of an addressable memory location 120 (FIG. 1C). Alternatively, the logical PAD 103 decodes the PAD address 116 to a secondary physical address 117 of FIG. 1D. The example PAD 104 reads the value stored in the addressable memory location 120 corresponding to the addressable memory location and returns the read value (block 1608). The example PAD 104 returns an acknowledge communication to the processor 108 (block 1610). The example method of FIG. 16 then returns to a calling process or function such as the example method of FIG. 14, and the example method of FIG. 16 ends.

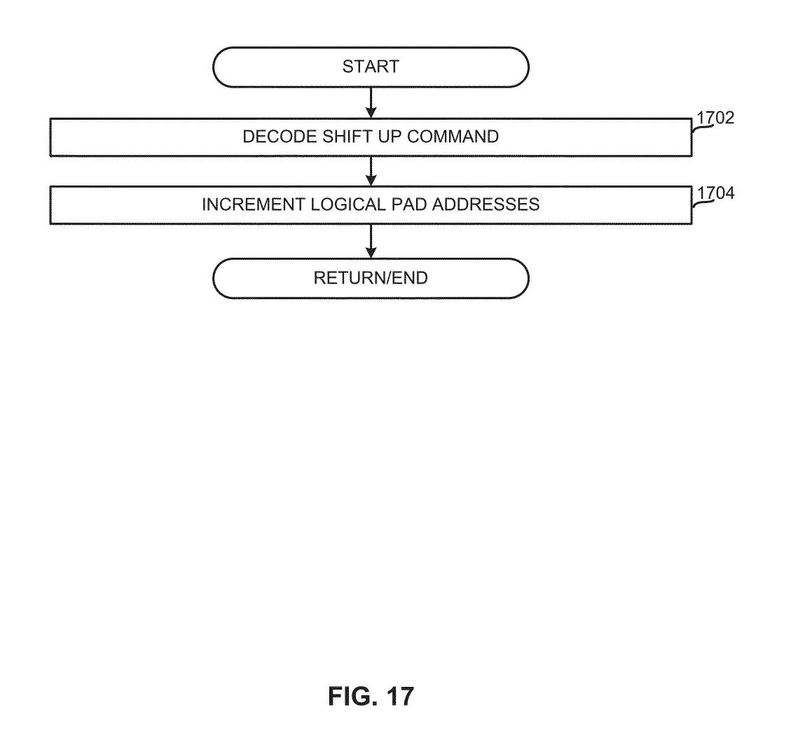

FIG. 17 is a flowchart representative of an example method to execute a shift up command (CMD_SHIFT_UP) using the example address translator 102 and the example PAD 104 of FIGS. 1A-1D and 3-5. The example method of FIG. 17 may be used to implement block 1408 of FIG. 14 to execute shift up commands. FIG. 17 begins when the example PAD 104 decodes a shift up command (block 1702). The PAD address modifier 112 increments the PAD address 116 of the logical PADs 103 (block 1704). The example method of FIG. 17 then returns to a calling process or function such as the example method of FIG. 14. and the example method of FIG. 17 ends.

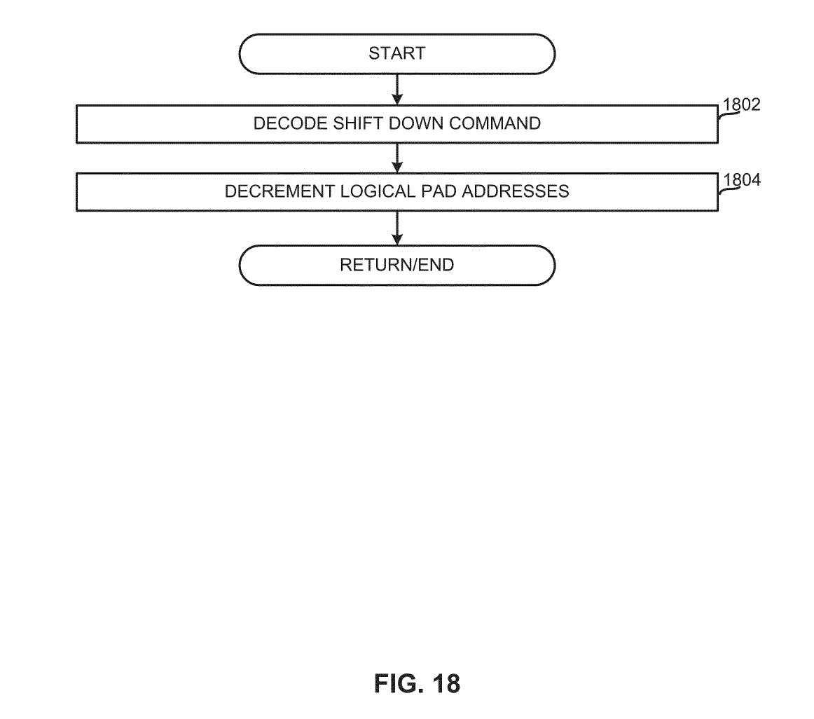

FIG. 18 is a flowchart representative of an example method to execute a shift down command (CMD_SHIFT_DN) using the example address translator 102 and the example PAD 104 of FIGS. 1A-1D and 3-5. The example method of FIG. 18 may be used to implement block 1408 of FIG. 14 to execute shift up commands. FIG. 18 begins when the example PAD 104 decodes a shift down command (block 1802). The PAD address modifier 112 decrements the PAD address 116 of the logical PADs 103 (block 1804). The example method of FIG. 18 then returns to a calling process or function such as the example method of FIG. 14, and the example method of FIG. 18 ends.

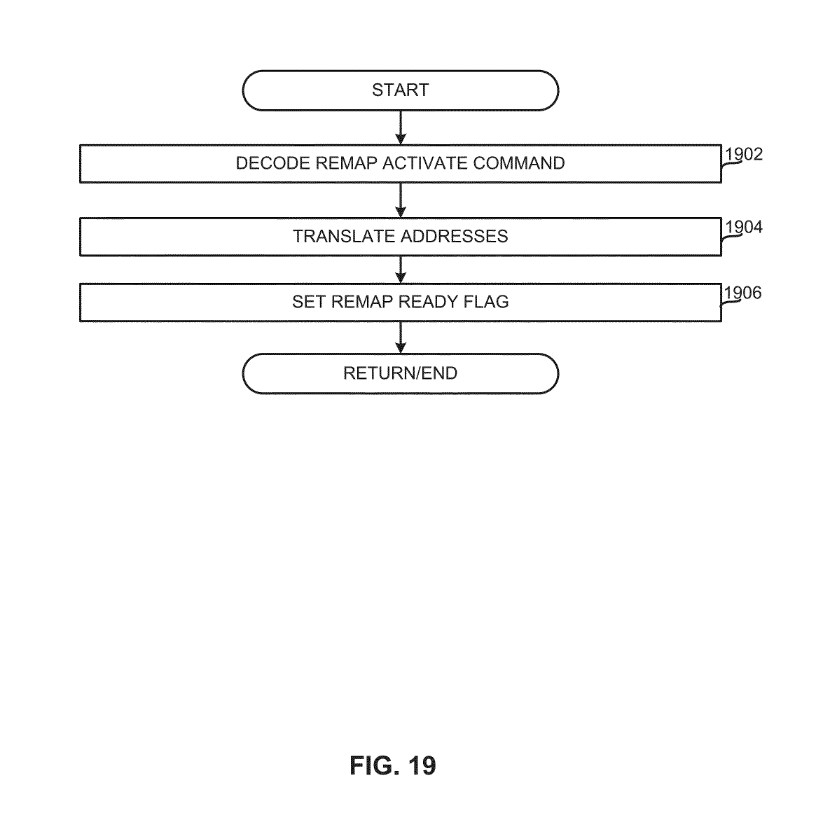

FIG. 19 is a flowchart representative of an example method to execute a remap activate command (CMD_REMAP_ACTIVATE) using the example address translator 102 and the example PAD 104 of FIGS. 1A-1D and 2-4. The example method of FIG. 19 may be used to implement block 1408 of FIG. 14 to execute remap activate commands. FIG. 19 begins when the example PAD 104 decodes a remap activate command (block 1902). The example address translator 102 translates the host physical addresses specified in the remap activate command into PAD addresses (block 1904). For example, the address translator 102 may translate host physical addresses 114 of FIGS. 1C and 1D into PAD addresses 116 of FIGS. 1C and 1D. The PAD address modifier 112 sets the remap ready flags of the logical PADs 103 (block 1906). The example method of FIG. 19 then returns to a calling process or function such as the example method of FIG. 14, and the example method of FIG. 19 ends.

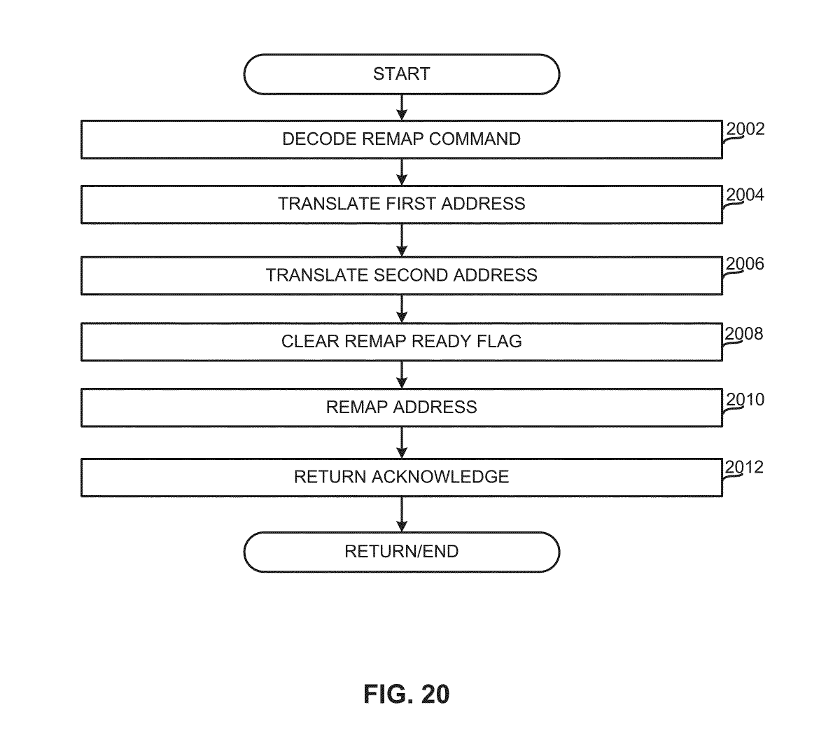

FIG. 20 is a flowchart representative of an example method to execute a remap command (CMD_REMAP) using the example address translator 102 and the example PAD 104 of FIGS. 1A-1D and 3-5. The example method of FIG. 20 may be used to implement block 1408 of FIG. 14 to execute remap commands. FIG. 20 begins when the example PAD 104 decodes a remap command (block 2002). The example address translator 102 translates a first host physical address specified in the remap command into a PAD address (block 2004). For example, the address translator 102 may translate a host physical address 114 of FIGS. 1C and 1D into a PAD address 116 of FIGS. 1C and 1D. The example address translator 102 translates a second host physical address specified in the remap command into a PAD address (block 2006). The example PAD address modifier 112 clears the remap ready flag of a logical PAD 103 corresponding to the first decoded logical PAD address (block 2008). The PAD address modifier 112 sets the PAD address of the example logical PAD 103 to the second translated PAD address (block 2010). The example PAD 104 returns an acknowledge communication to the processor 108 (block 2012). The example method of FIG. 20 then returns to a calling process or function such as the example method of FIG. 14, and the example method of FIG. 20 ends.

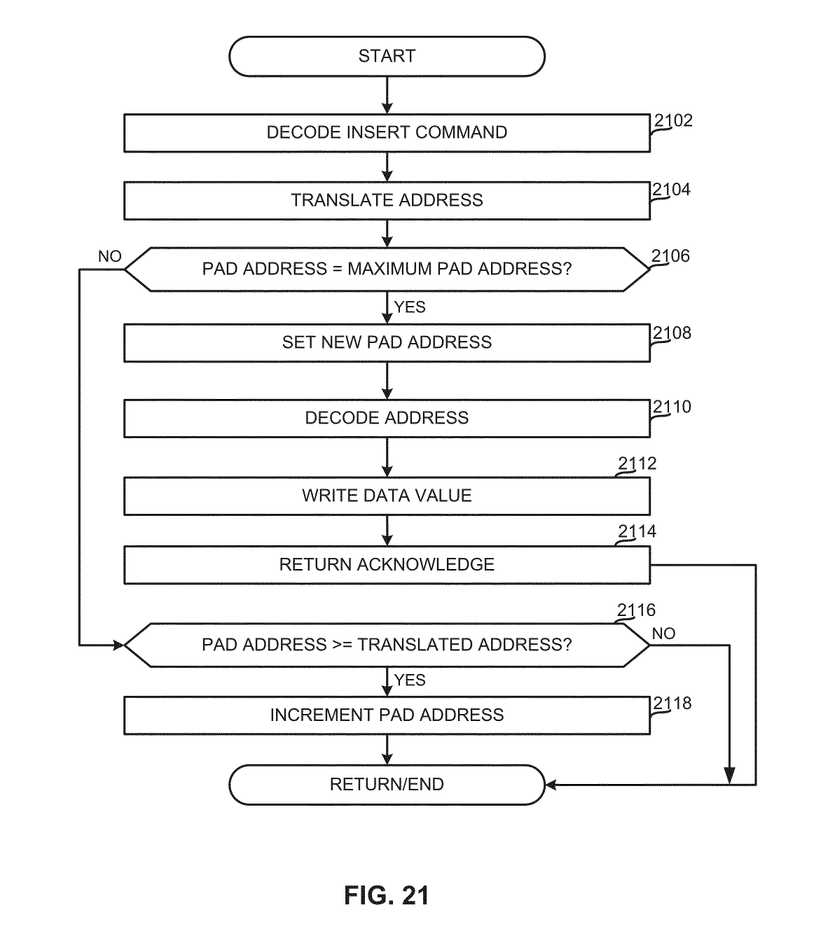

FIG. 21 is a flowchart representative of an example method to execute an insert command (CMD_INSERT) using the example address translator 102 and the example PAD 104 of FIGS. 1A-1D and 2-4. The example method of FIG. 21 may be used to implement block 1408 of FIG. 14 for insert commands. FIG. 21 begins when the example PAD 104 decodes an insert command (block 2102). The example address translator 102 translates a host physical address specified in the insert command into a PAD address (block 2104). For example, the address translator 102 may translate a host physical address 114 of FIGS. 1C and 1D into a PAD address 116 of FIGS. 1C and 1D.

The PAD address modifier 112 determines which logical PAD 103 (FIGS. 1C and 1D) has a PAD address 116 equal to a maximum PAD address 116 of an array of logical PADs 103 (block 2106). The PAD address modifier 112 sets the PAD address 116 of a logical PAD 103 having the maximum PAD address to the translated PAD address (block 2108). The logical PAD 103 then decodes its PAD address 116 to a hardware memory address (block 2110). For example, the logical PAD 103 can decode the PAD address 116 to a corresponding addressable memory location 120 (FIGS. 1C and 1D). The PAD 104 writes the value specified in the received insert command to the addressable memory location 120 (block 2112). The PAD 104 returns an acknowledge communication to the processor 108 (block 2114).

If a PAD address 116 of a logical PAD 103 does not have the maximum PAD address of the array of logical PADs 103, the PAD address modifier 112 determines which PAD addresses 116 are greater than or equal to the translated PAD address (block 2116). For a logical PAD 103 having a PAD address 116 greater than or equal to the translated PAD address (block 2116), the PAD address modifier 112 increments the PAD address 116 by one (block 2118). If a PAD address 116 of a logical PAD 103 is not greater than or equal to the translated PAD address (block 2116), or after the PAD address modifier 112 increments the PAD address 116 by one (block 2118), or after the PAD 104 returns an acknowledge communication to the processor 108 (block 2114), the example method of FIG. 21 returns to a calling process or function such as the example method of FIG. 14, and the example method of FIG. 21 ends.

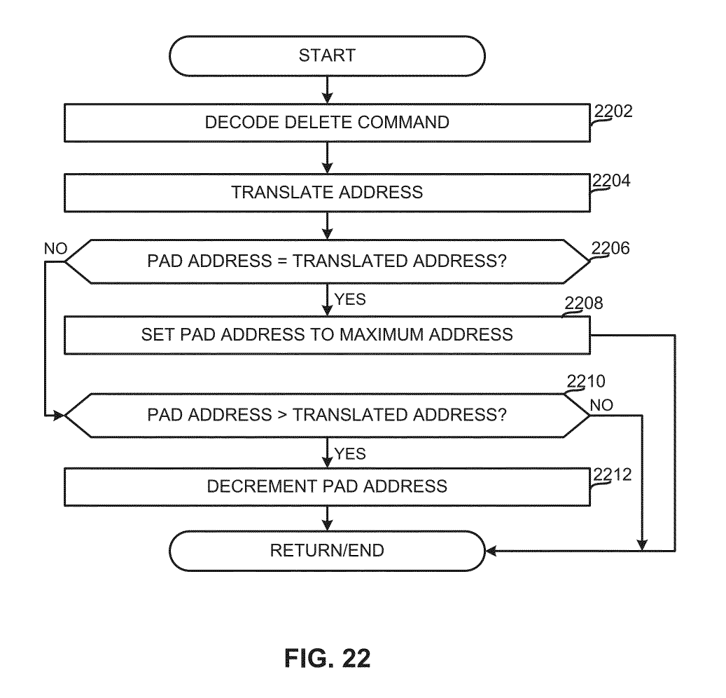

FIG. 22 is a flowchart representative of an example method to execute a delete command (CMD_DELETE) using the example address translator 102 and the example PAD 104 of FIGS. 1A-1D and 2-4. The example method of FIG. 22 may be used to implement block 1408 of FIG. 14 to execute delete commands. FIG. 22 begins when the example PAD 104 decodes a delete command (block 2202). The example address translator 102 translates a host physical address specified in the delete command into a PAD address (block 2204). For example, the address translator 102 may translate a host physical address 114 of FIGS. 1C and 1D into a PAD address 116 of FIGS. 1C and 1D.

The PAD address modifier 112 determines which PAD address 116 is equal to the translated PAD address (block 2206). If a PAD address 116 of a logical PAD 103 is equal to the translated PAD address (block 2206), the PAD address modifier 112 sets the PAD address 116 of the logical PAD 103 to the maximum PAD address of an array of logical PADs 103 (block 2208). If a PAD address 116 of a logical PAD 103 is not equal to the translated PAD address (block 2206), the PAD address modifier 112 determines whether the PAD address 116 of the logical PAD 103 is greater than the translated PAD address (block 2210). If the PAD address 116 of the logical PAD 103 is greater than the translated PAD address (block 2210), the PAD address modifier 112 decrements the PAD address 116 of the logical PAD 103 by one (block 2212). If the PAD address modifier 112 determines that the PAD address 116 of the logical PAD 103 is not greater than the translated PAD address (block 2210), or after decrementing the PAD address 116 of the logical PAD 103 by one (block 2212), or after setting the PAD address 116 of the logical PAD 103 to the maximum PAD address of the array of logical PADs 103 (block 2208), the example method of FIG. 18 returns to a calling process or function such as the example method of FIG. 14, and the example method of FIG. 22 ends.

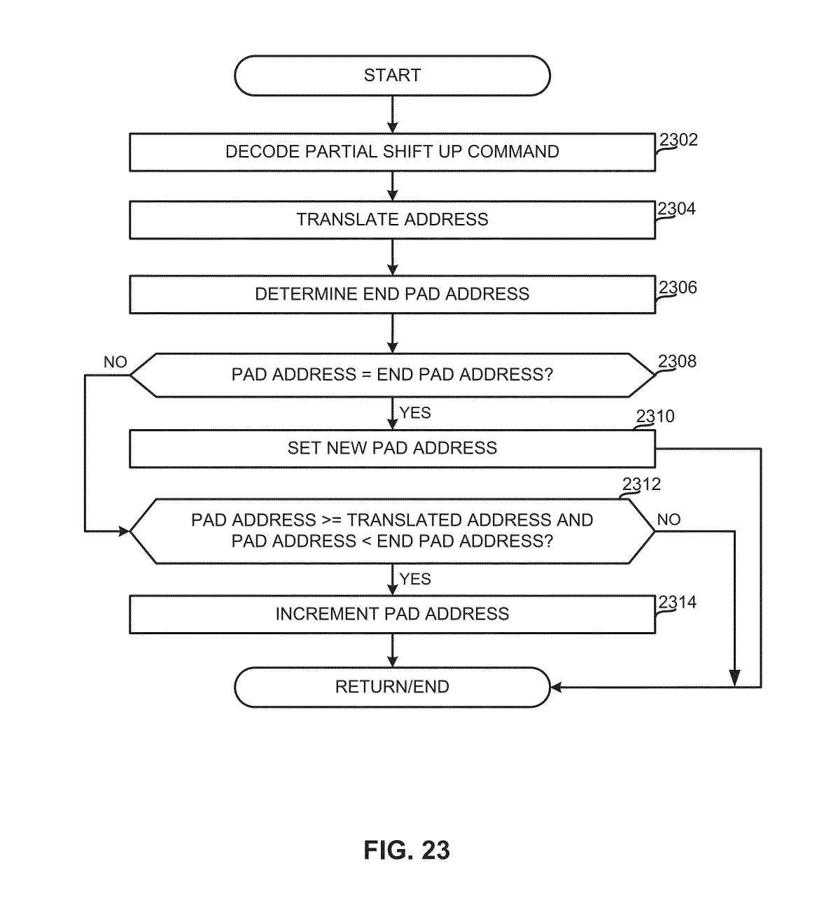

FIG. 23 is a flowchart representative of an example method to execute a partial shift up command (CMD_SHIFT_UP_P) using the example address translator 102 and the example PAD 104 of FIGS. 1A-1D and 2-4. The example method of FIG. 23 may be used to implement block 1408 of FIG. 14 to execute partial shift up commands. FIG. 23 begins when the example PAD 104 decodes a partial shift up command (block 2302). The example address translator 102 translates a host physical address specified in the partial shift up command into a PAD address (block 2304). For example, the address translator 102 may translate a host physical address 114 of FIGS. 1C and 1D into a PAD address 116 of FIGS. 1C and 1D. The example address translator 102 determines an end PAD address by adding the length specified in the partial shift up command to the translated PAD address and subtracting one (block 2306). The length specified in the partial shift up command represents the number of logical PADs 103 whose PAD address is to be shifted up.

The PAD address modifier 112 determines which logical PAD 103 (FIGS. 1C and 1D) has a PAD address 116 equal to the determined end PAD address (block 2308). The PAD address modifier 112 sets the PAD address 116 of the logical PAD 103 having the determined end PAD address to the translated PAD address (block 2310).

If a PAD address 116 of a logical PAD 103 is not equal to the determined end PAD address, the PAD address modifier 112 determines which PAD addresses 116 are greater than or equal to the translated PAD address and less than the determined end PAD address (block 2312). For a logical PAD 103 having a PAD address 116 greater than or equal to the translated PAD address and less than the determined end PAD address (block 2312), the PAD address modifier 112 increments the PAD address 116 by one (block 2314). If a PAD address 116 of a logical PAD 103 is not greater than or equal to the translated PAD address and less than the determined end PAD address (block 2312), or after the PAD address modifier 112 increments the PAD address 116 by one (block 2314), or after the PAD address modifier 112 sets the PAD address 116 of the logical PAD 103 to the translated PAD address (block 2310), the example method of FIG. 23 returns to a calling process or function such as the example method of FIG. 14, and the example method of FIG. 23 ends.

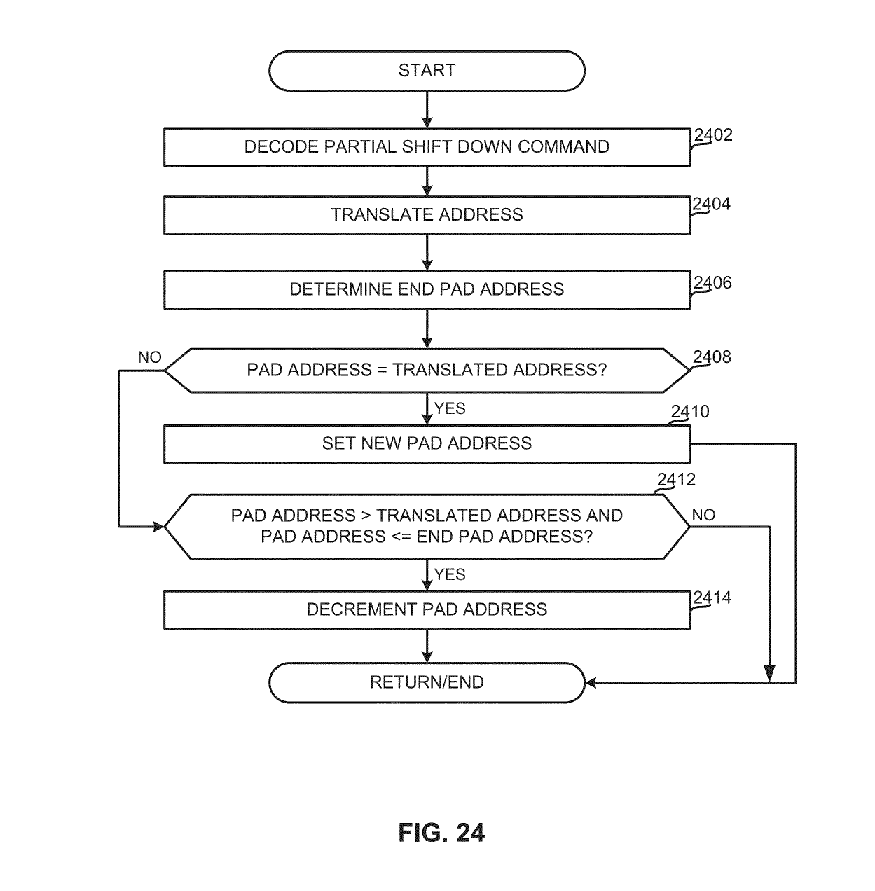

FIG. 24 is a flowchart representative of an example method to execute a partial shift down command (CMD_SHIFT_DN_P) using the example address translator 102 and the example PAD 104 of FIGS. 1A-1D and 2-4. The example method of FIG. 24 may be used to implement block 1408 of FIG. 14 to execute partial shift down commands. FIG. 24 begins when the example PAD 104 decodes a partial shift down command (block 2402). The example address translator 102 translates a host physical address specified in the partial shift down command into a PAD address (block 2404). For example, the address translator 102 may translate a host physical address 114 of FIGS. 1C and 1D into a PAD address 116 of FIGS. 1C and 1D. The example address translator 102 determines a subset end PAD address by adding the length specified in the partial shift down command to the translated PAD address and subtracting one (block 2406). The length specified in the partial shift down command represents the number of logical PADs 103 whose PAD address is to be shifted down.

The PAD address modifier 112 determines which logical PAD 103 (FIGS. 1C and 1D) has a PAD address 116 equal to the translated PAD address (block 2408). The PAD address modifier 112 sets the PAD address 116 of the logical PAD 103 having the translated PAD address to the determined subset end PAD address (block 2410).

If a PAD address 116 of a logical PAD 103 is not equal to the translated PAD address, the PAD address modifier 112 determines which PAD addresses 116 are greater than the translated PAD address and less than or equal to the determined subset end PAD address (block 2412). For a logical PAD 103 having a PAD address 116 greater than the translated PAD address and less than or equal to the determined subset end PAD address (block 2412), the PAD address modifier 112 decrements the PAD address 116 by one (block 2414). If a PAD address 116 of a logical PAD 103 is not greater than the translated PAD address and less than or equal to the determined subset end PAD address (block 2412), or after the PAD address modifier 112 decrements the PAD address 116 by one (block 2414), or after the PAD address modifier 112 sets the PAD address 116 of the logical PAD 103 to the determined subset end PAD address (block 2410), the example method of FIG. 24 returns to a calling process or function such as the example method of FIG. 14, and the example method of FIG. 24 ends.

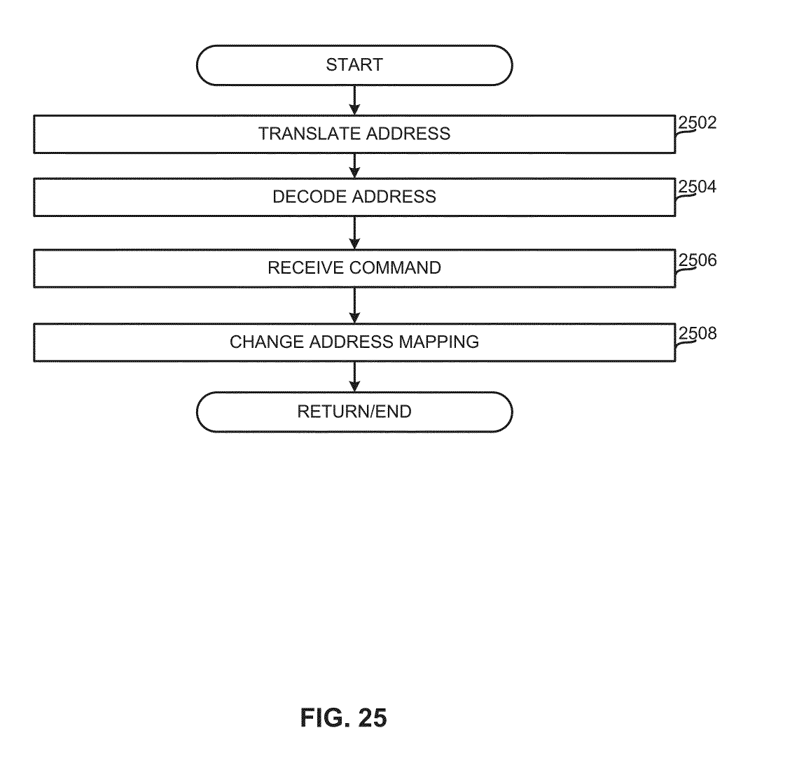

FIG. 25 depicts a flow diagram of an example method to perform commands received at the PAD 104 of FIGS. 1A-1D and 2-3, such as the commands described above in connection with FIGS. 4-24 and/or any other commands. Initially, the address translator translates a received host physical address 114 to a PAD address 116 (block 2502). For example, the address translator 102 may translate a host physical address 114 of FIGS. 1C and 1D into a PAD address 116 of FIGS. 1C and 1D corresponding to a logical PAD 103. The example logical PAD 103 decodes the translated PAD address to a hardware memory address (block 2504). For example, the PAD 104 can decode the PAD address 116 received from the address translator 102 to a corresponding hardware memory address 118 of an addressable memory location 120 (FIGS. 1C and 1D). The PAD 104 receives a command that involves associating the host physical address 114 to a different hardware memory address 118 of an addressable memory location 120 (block 2506). The example PAD address modifier 112 changes the PAD address 116 of a logical PAD 103 (block 2508). In the illustrated example, the PAD address modifier 112 changes the PAD address 116 in connection with executing a received command for which modifying PAD addresses (e.g., remapping PAD addresses) decrease (or eliminate) a quantity of data moves and/or copies to execute the received command. The example method of FIG. 25 then ends.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. An apparatus comprising:
an address translator to translate a first host physical address to a first intermediate address; and
a programmable address decoder to decode the first intermediate address to a first hardware memory address of a first addressable memory location in a memory, the programmable address decoder to receive a first command to associate the first host physical address with a second addressable memory location in the memory by changing a mapping between the first intermediate address and a second hardware memory address of the second addressable memory location.

2. The apparatus of claim 1, wherein the address translator is to translate a second host physical address to a second intermediate address, and the programmable address decoder is to decode the second intermediate address to a third hardware memory address of a third addressable memory location in the memory, the programmable address decoder to receive a second command to associate the second host physical address with the first addressable memory location by changing a mapping between the second intermediate address and the first hardware memory address.

3. The apparatus as defined in claim 1, wherein the first addressable memory location is one of a plurality of addressable memory locations that form an array of addressable memory locations, each addressable memory location of the array of addressable memory locations has a different hardware memory address, each of the plurality of addressable memory locations being associated with a corresponding intermediate address, the programmable address decoder to decode the intermediate addresses to corresponding hardware memory addresses of the addressable memory locations; and
the programmable address decoder to receive a second command to change a mapping between the intermediate address and the hardware memory addresses to re-map the intermediate addresses with different ones of the plurality of addressable memory locations.

4. The apparatus as defined in claim 3, further comprising an address modifier to change mappings between the intermediate addresses and the hardware memory addresses of the addressable memory locations.

5. The apparatus as defined in claim 1, wherein the address translator is to translate a second host physical address to a second intermediate address, the programmable address decoder to receive a second command to write a data value to the first addressable memory location, and further comprising an address modifier to associate the second host physical address with the first addressable memory location by mapping the second intermediate address to the first hardware memory address of the first addressable memory location.

6. A method comprising:
translating a first host physical address to a first intermediate address;
decoding the first intermediate address to a first secondary physical address;
decoding the first secondary physical address to a hardware memory address of a first addressable memory location in a memory; and
receiving a first command to associate the first host physical address with a second addressable memory location in the memory by changing a mapping between the first intermediate address and a second secondary physical address that decodes to a second hardware memory address of the second addressable memory location.

7. The method of claim 6, further comprising:
translating a second host physical address to a second intermediate address;
decoding the second intermediate address to a third secondary physical address that decodes to a third hardware memory address of a third addressable memory location in the memory; and
receiving a second command to associate the second host physical address with the first secondary physical address by changing a mapping of the second intermediate address to the first secondary physical address.

8. The method of claim 6, wherein the first addressable memory location is one of a plurality of addressable memory locations that form an array of addressable memory locations, each addressable memory location of the array of addressable memory locations having a different hardware memory address;
each of the hardware memory addresses associated with a secondary physical address, wherein each of the secondary physical addresses decodes to one of the hardware memory addresses;
each of the secondary physical addresses being associated with an intermediate address, wherein each of the intermediate addresses decodes to one of the secondary physical addresses; and
further comprising receiving a second command to change a mapping between the intermediate addresses and the plurality of addressable memory locations to associate the intermediate addresses with different ones of the secondary physical addresses, each of the secondary physical addresses being associated with one of the plurality of addressable memory locations of the array of addressable memory locations.

9. The method of claim 8, further comprising changing the order of the intermediate addresses relative to the order of the secondary physical addresses that are associated with the intermediate addresses.

10. The method of claim 6, further comprising translating a second host physical address to a second intermediate address; and
receiving a second command to write a data value to the first addressable memory location and to associate the second host physical address with the first addressable memory location by changing a mapping between the second intermediate address and the first secondary physical address.

11. A tangible machine readable storage medium comprising instructions that, when executed, cause a machine to at least:
translate a first host physical address to a first intermediate address;
decode the first intermediate address to a first hardware memory address of a first addressable memory location in a memory; and
associate the first host physical address with a second addressable memory location in the memory in response to a first command by changing a mapping between the first intermediate address and a second hardware memory address of the second addressable memory location.

12. The storage medium as defined in claim 11, wherein the instructions, when executed, cause the machine to:
translate a second host physical address to a second intermediate address;
decode the second intermediate address to a third hardware memory address of a third addressable memory location in the memory; and
receive a second command to associate the second host physical address with the first addressable memory location by changing a mapping of the second intermediate address to the first hardware memory address.

13. The storage medium as defined in claim 11, wherein the first addressable memory location is one of a plurality of addressable memory locations that form an array of addressable memory locations, each addressable memory location of the array of addressable memory locations having a different hardware memory address;
each of the plurality of addressable memory locations being associated with a corresponding intermediate address, wherein each of the intermediate addresses decodes to one of the addressable memory locations; and
when executed, the instructions further cause the machine to change a mapping between the intermediate address and the hardware memory address in response to a second command to re-map the intermediate addresses with different ones of the plurality of addressable memory locations.

14. The storage medium as defined in claim 13, wherein the instructions, when executed, cause the machine to change the mapping between the intermediate addresses and the hardware memory addresses of the addressable memory locations.

15. The storage medium as defined in claim 11, wherein the instructions, when executed, cause the machine to:
translate a second host physical address to a second intermediate address;
write a data value to the first addressable memory location in response to a second command; and
associate the second host physical address with the first addressable memory location by mapping the second intermediate address to the first hardware memory address of the first addressable memory location.
